(19) United States
(12) Patent Application Publication
(10) Pub. No.: US 2006/0104283 A1
(43) Pub. Date: May 18, 2006

(54) Information processing apparatus and method, recording medium, and program

(75) Inventor: Manami Suzuki, Tokyo (JP)

Correspondence Address: WOLF GREENFIELD & SACKS, PC;FEDERAL RESERVE PLAZA, 600 ATLANTIC AVENUE, BOSTON, MA, 02210-2206, US

(73) Assignee: Sony Corporation, Tokyo (JP)

(21) Appl. No.: 11/268,901

(22) Filed: Nov. 8, 2005

(30) Foreign Application Priority Data
Nov. 8, 2004 (JP) P2004-323180

(51) Int. Cl. H04L 12/56

(52) U.S. Cl. 370/395.2; 370/468

(57) ABSTRACT

Disclosed herein is an information processing system having a first information processing apparatus and a second information processing apparatus for controlling communication with the first apparatus via a network, the first apparatus including, an attaching unit for attaching free space information of a send buffer in which data to be transmitted to the second apparatus to first data to be transmitted to the second apparatus, and a first transmitting unit for transmitting the first data attached with the send buffer free space information by the attaching unit to the second apparatus, the second apparatus including, a second transmitting unit for transmitting second data to the first apparatus, a data receiving unit for receiving the first data transmitted from the first apparatus, a free space determining unit for determining whether the send buffer free space is smaller than a predetermined value on the basis of the send buffer free space information attached to the first data received by the data receiving unit, and a communication control unit for, if the send buffer free space is found smaller than the predetermined value by the free space determining unit, controlling communication with the first apparatus such that transmission of the first data by the first transmitting unit is executed before transmission of the second data by the second transmitting unit.

### CROSS REFERENCES TO RELATED APPLICATIONS

The present invention contains subject matter related to Japanese Patent Application JP 2004-323180 filed in the Japanese Patent Office on Nov. 8, 2004, the entire contents of which being incorporated herein by reference.

### BACKGROUND OF THE INVENTION

The present invention relates to an information processing apparatus and method, a recording medium, and a program and, more particularly, to an information processing apparatus and method, a recording medium, and a program adapted to execute optimum inter-device communication only by controlling one of the communicating devices by attaching buffer information of the other party to data that is transmitted or received between the devices.

An imaging device is known that is composed of a camera block for taking an image of a subject and a recording/reproducing block for recording the image data captured by the camera block to a recording medium and reproducing the image data therefrom. These recording/reproducing block and camera block are interconnected with a serial line, the communication therebetween being carried out over this serial line.

In such an imaging device as described above, it is often a general practice for the camera block to execute control of the imaging device and both the recording/reproducing block and camera block to control the communication therebetween.

It should be noted that Japanese Patent Laid-open No. Hei 11-175270 (hereinafter referred to as Patent Document 1) discloses a system in which the sender side transmits print data and control commands over different channels over a network and the receiver side monitors the free space of the receiving buffer and predicts the reception chance of control commands, thereby controlling the reception rate of the print data in accordance with the prediction. Namely, patent document 1 describes an example in which the communication is controlled by both the sending and receiver sides.

### SUMMARY OF THE INVENTION

However, the above-mentioned control of the communication by both the recording/reproducing block and camera block present a problem that the modification of specifications of any of control commands requires the modification of the settings of both the sides, thereby taking much time and labor.

To circumvent this problem, a method may be proposed in which the control of the communication is executed only by one of the two blocks. However, if one of the two blocks attempts to execute control of the entire imaging device (namely, including the control of the communication between the recording/reproducing block and camera block), that block has only the information associated with the transmission data of itself; therefore, one block cannot have the information about the communication buffer status of the other block.

Consequently, any attempt to control the communication over the serial line by use of only the information associated with the transmission data of only one of the blocks may result in an unexpected status such as a communication buffer overflow on the other block. This may make it difficult to control the communication over the serial line.

It is therefore an object of the present invention to provide optimum communication between a plurality of devices through control by only one of the devices.

In carrying out the invention and according to one embodiment thereof, there is provided an information processing system having a first information processing apparatus and a second information processing apparatus for controlling communication with the first information processing apparatus via a network. The above-mentioned first information processing apparatus includes attaching means for attaching free space information of a send buffer in which data to be transmitted to the second information processing apparatus to first data to be transmitted to the second information processing apparatus; and first transmitting means for transmitting the first data attached with the send buffer free space information by the attaching means to the second information processing apparatus. The above-mentioned second information processing apparatus includes second transmitting means for transmitting second data to the first information processing apparatus; data receiving means for receiving the first data transmitted from the first information processing apparatus; free space determining means for determining whether the send buffer free space is smaller than a predetermined value on the basis of the send buffer free space information attached to the first data received by the data receiving means; and communication control means for, if the send buffer free space is found smaller than the predetermined value by the free space determining means, controlling communication with the first information processing apparatus such that transmission of the first data by the first transmitting means is executed before transmission of the second data by the second transmitting means.

The above-mentioned second data is control command data and the above-mentioned first data is at least one of notification data for notifying that the second data has been received by the first information processing apparatus and result data indicative of a result of processing executed by the first information processing apparatus in response to the second data.

In carrying out the invention and according to another embodiment thereof, there is provided a first information processing apparatus that executes communication via a network. The above-mentioned first information processing apparatus includes receiving means for receiving first data from another information processing apparatus; attaching means for attaching free space information of a send buffer in which data to be transmitted to the another information processing apparatus to second data to be transmitted to the another information processing apparatus; and transmitting means for transmitting the second data attached with the send buffer free space information to the another information processing apparatus. In the first information processing apparatus, if the send buffer free space is found smaller than a predetermined value by the another information processing apparatus on the basis of the send buffer free space information attached to the second data transmitted by the transmitting means, transmission of the second data by the transmitting means is executed before reception of the first data by the receiving means.

The above-mentioned first data is control command data and the above-mentioned second data is at least one of notification data for notifying that the first data has been received by the receiving means and result data indicative of a result of processing executed in accordance with the first data.

If there are the notification data and the result data as candidates for the second data, the transmitting means transmits the notification data rather than the result data.

The above-mentioned first information processing apparatus further includes free space determining means for determining whether a free space of a receive buffer in which the first data received by the receiving means is stored. If the receive buffer free space is found smaller than a predetermined value by the free space determining means, the transmitting means puts transmission of the notification data in a standby state and transmits the result data.

In carrying out the invention and according to still another embodiment thereof, there is provided a first information processing method for an information processing apparatus that executes communication via a network. This method includes steps of receiving first data from another information processing apparatus; attaching free space information of a send buffer in which data to be transmitted to the another information processing apparatus to second data to be transmitted to the another information processing apparatus; and transmitting the second data attached with the send buffer free space information to the another information processing apparatus. In this method, if the send buffer free space is found smaller than a predetermined value by the another information processing apparatus on the basis of the send buffer free space information attached to the second data transmitted in the transmitting step, transmission of the second data in the transmitting step is executed before reception of the first data in the receiving step.

In carrying out the invention and according to yet another embodiment thereof, there is provided a first recording medium recording a program for making a computer execute processing of communication via a network. The above-mentioned program includes the steps of: receiving first data from another information processing apparatus; attaching free space information of a send buffer in which data to be transmitted to the another information processing apparatus to second data to be transmitted to the another information processing apparatus; and transmitting the second data attached with the send buffer free space information to the another information processing apparatus. In this program, if the send buffer free space is found smaller than a predetermined value by the another information processing apparatus on the basis of the send buffer free space information attached to the second data transmitted in the transmitting step, transmission of the second data in the transmitting step is executed before reception of the first data in the receiving step.

In carrying out the invention and according to a different embodiment thereof, there is provided a first program for making a computer execute processing of communication via a network. The above-mentioned first program includes the steps of: receiving first data from another information processing apparatus; attaching free space information of a send buffer in which data to be transmitted to the another information processing apparatus to second data to be transmitted to the another information processing apparatus; and transmitting the second data attached with the send buffer free space information to the another information processing apparatus. In the first program, if the send buffer free space is found smaller than a predetermined value by the another information processing apparatus on the basis of the send buffer free space information attached to the second data transmitted in the transmitting step, transmission of the second data in the transmitting step is executed before reception of the first data in the receiving step.

In carrying out the invention and according to a still different embodiment thereof, there is provided a second information processing apparatus for controlling communication to be executed via a network. The above-mentioned second information processing apparatus includes transmitting means for transmitting first data to another information processing apparatus; receiving means for receiving second data attached with free space information of a send buffer of the another information processing apparatus, the second data being transmitted therefrom; free space determining means for determining whether the send buffer free space is smaller than a predetermined value on the basis of the send buffer free space information attached to the second data received by the receiving means; and communication control means for, if the send buffer free space is found smaller than the predetermined value by the free space determining means, controlling communication with the another information processing apparatus so as to execute reception of the second data by the receiving means before transmission of the first data by the transmitting means.

The above-mentioned first data is control command data and the second data is at least one of notification data for notifying that the first data transmitted by the transmitting means has been received by the another information processing apparatus and result data indicative of a result of processing executed in response to the first data in the another information processing apparatus.

The above-mentioned communication control means controls the another information processing apparatus so as to prohibit transmission of next first data by the transmitting means until the receiving means receives, as the second data, the notification data corresponding to the first data transmitted by the transmitting means, thereby preferentially executing reception of the second data by the receiving means.

In carrying out the invention and according to yet different embodiment thereof, there is provided a second information processing method for an information processing apparatus for controlling communication to be executed via a network. The above-mentioned second information processing method includes the steps of: transmitting first data to another information processing apparatus; receiving second data attached with free space information of a send buffer of the another information processing apparatus, the second data being transmitted therefrom; determining whether the send buffer free space is smaller than a predetermined value on the basis of the send buffer free space information attached to the second data received in the receiving step; and, if the send buffer free space is found smaller than the predetermined value in the free space determining step, controlling communication with the another information processing apparatus so as to execute reception of the second data in the receiving step before transmission of the first data in the transmitting step.

In carrying out the invention and according to a separate embodiment thereof, there is provided a second recording medium recording a program for making a computer execute processing of controlling communication to be executed via a network. The above-mentioned program includes the steps of: transmitting first data to another information processing apparatus; receiving second data attached with free space information of a send buffer of the another information processing apparatus, the second data being transmitted therefrom; determining whether the send buffer free space is smaller than a predetermined value on the basis of the send buffer free space information attached to the second data received in the receiving step; and, if the send buffer free space is found smaller than the predetermined value in the free space determining step, controlling communication with the another information processing apparatus so as to execute reception of the second data in the receiving step before transmission of the first data in the transmitting step.

In carrying out the invention and according to a still separate embodiment thereof, there is provided a second program for making a computer execute processing of controlling communication to be executed via a network. The above-mentioned second program includes the steps of: transmitting first data to another information processing apparatus; receiving second data attached with free space information of a send buffer of the another information processing apparatus, the second data being transmitted therefrom; determining whether the send buffer free space is smaller than a predetermined value on the basis of the send buffer free space information attached to the second data received in the receiving step; and, if the send buffer free space is found smaller than the predetermined value in the free space determining step, controlling communication with the another information processing apparatus so as to execute reception of the second data in the receiving step before transmission of the first data in the transmitting step.

The free space information of the send buffer in which data to be transmitted to the second information processing apparatus is stored is attached to the first data to be transmitted by the first information processing apparatus to the second information processing apparatus and the first data thus attached with the send buffer free space information is transmitted to the second information processing apparatus. The second data is transmitted by the second information processing apparatus to the first information processing apparatus and the first data from the first information processing apparatus is received by the second information processing apparatus. Then, on the basis of the send buffer free space information attached to the received first data, it is determined whether the free space of the send buffer is smaller than a predetermined value. If the free space is found smaller, the communication with the second information processing apparatus is controlled so as to prefer the transmission of the first data to the transmission of the second data.

The first data from an information processing apparatus is received. The free space information of the send buffer in which the data to be transmitted to the information processing apparatus is stored is attached to the second data to be transmitted to the information processing apparatus. The second data thus attached with the send buffer free space information is transmitted to the information processing apparatus. Then, if the free space of the send buffer is found smaller than a predetermined value by the information processing apparatus on the basis of the send buffer free space information attached to the second data, the transmission of the second data is preferred to the transmission of the first data.

The first data is transmitted to the information processing apparatus. The second data attached with send buffer free space information of the information processing apparatus is received, the send buffer free space information being transmitted from the information processing apparatus. It is determined whether the send buffer free space is smaller than a predetermined value on the basis of the send buffer free space information attached to the received second data. If the send buffer free space is found smaller, the communication with the information processing apparatus is controlled so as to prefer the reception of the second data to the transmission of the first data.

A network denotes a mechanism in which at least two interconnected devices are able to communicate information with each other. The devices that communicate with each other via a network may be standalone devices or component blocks that configure one apparatus.

Communication may be wireless communication or wired communication or both in which wireless communication is executed in one section and wired communication is executed in another section. Communication may also be that wired communication is executed from one device to another and wireless communication is executed from the latter to the former.

As described and according to the present invention, the optimum communication between devices may be executed only by controlling one device. In addition, the embodiment of the present invention facilitates the change of command specifications.

### BRIEF DESCRIPTION OF THE DRAWINGS

FIG. 1 is a block diagram illustrating an exemplary configuration of a recording/reproducing apparatus practiced as one embodiment of the invention;

FIG. 2 is a block diagram illustrating a detail exemplary configuration of a communication block of a camera block and a communication block of a recording/reproducing block shown in FIG. 1;

FIG. 3 is a block diagram illustrating a detail exemplary configuration of a camera communication interface and a main communication interface;

FIG. 4 is a diagram illustrating data that is transmitted and received between the camera block and the recording/reproducing block shown in FIG. 1;

FIG. 5 is a flowchart indicative of image display control processing of the recording/reproducing apparatus shown in FIG. 1;

FIG. 6 is a flowchart indicative of command communication control processing that is executed in the steps shown in FIG. 5;

FIG. 7 is a diagram illustrating command communication control processing shown in FIG. 6;

FIG. 8 is a flowchart indicative of command packet transmission control processing of the recording/reproducing block to be executed in step S24 shown in FIG. 6;

FIG. 9 is a flowchart indicative of command packet transmission control processing of the recording/reproducing block to be executed in step S24 shown in FIG. 6;

FIG. 10 is a flowchart indicative of command packet reception control processing of the camera block corresponding to the processing shown in FIG. 8;

FIG. 11 is a flowchart continued from the flowchart shown in FIG. 8;

FIG. 12 is a flowchart indicative of a relationship of the processing shown in FIGS. 8, 9, 10, and 11;

FIG. 13 is a flowchart indicative of command ACK packet transmission control processing of the camera block to be executed in step S27 shown in FIG. 6;

FIG. 14 is a flowchart indicative of command ACK packet reception processing of the recording/reproducing block corresponding to the processing shown in FIG. 13;

FIG. 15 is an arrow chart indicative of a relationship between the processing shown in FIG. 13 and the processing shown in FIG. 14;

FIG. 16 is a flowchart indicative of result packet transmission processing of the camera block described in step S31 of FIG. 6;

FIG. 17 is a flowchart indicative of result packet reception control processing of the recording/reproducing block corresponding to the processing shown in FIG. 16;

FIG. 18 is an arrow chart indicative of a relationship between the processing shown in FIG. 16 and the processing shown in FIG. 17;

FIG. 19 is an arrow chart indicative of an example of packet transmission/reception control processing to be executed when packet send requests are made in a duplicate manner;

FIG. 20 is an arrow chart indicative of another example of packet transmission/reception control processing to be executed when packet send requests are made in a duplicate manner;

FIG. 21 is an arrow chart indicative of still another example of packet transmission/reception control processing to be executed when packet send requests are made in a duplicate manner;

FIG. 22 is an arrow chart indicative of yet another example of packet transmission/reception control processing to be executed when packet send requests are made in a duplicate manner; and

FIG. 23 is a block diagram illustrating an exemplary configuration of a personal computer to which the present invention is applied.

### DETAILED DESCRIPTION OF THE PREFERRED EMBODIMENTS

The following describes embodiments of the present invention with reference to accompanying drawings.

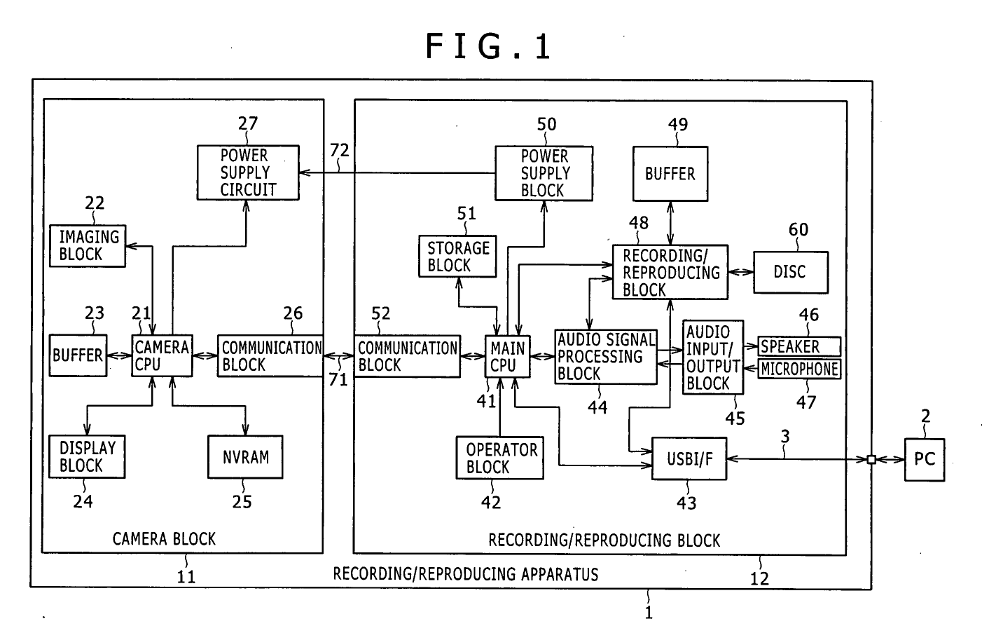

Now, referring to FIG. 1, there is shown a block diagram illustrating an exemplary configuration of a recording/reproducing apparatus practiced as one embodiment of the invention.

As shown in FIG. 1, a recording/reproducing apparatus 1 and a PC (Personal Computer) 2 are interconnected with a USB (Universal Serial Bus) cable 3, thereby providing bidirectional communication therebetween.

The recording/reproducing apparatus 1 is composed of a camera block 11 and a recording/reproducing block 12.

The camera block 11 is composed of a camera CPU 21, an imaging block 22, a buffer 23, a display block 24, an NVRAM (Non Volatile Random Access Memory) 25, a communication block 26, and a power supply block 27, thereby controlling the imaging processing executed in the imaging block 22 and the displaying of images on the display block 24.

The Recording/reproducing block 12 is composed of a main CPU 41, an operator block 42, a USB I/F (Interface) 43, an audio signal processing block 44, an audio input/output bloc 45, a speaker 46, a microphone 47, a recording/reproducing block 48, a buffer 49, a power supply block 50, a storage block 51, and a communication block 52, thereby controlling the access to images or music (or data thereof) recorded to a disc 60 loaded on the recording/reproducing block 48.

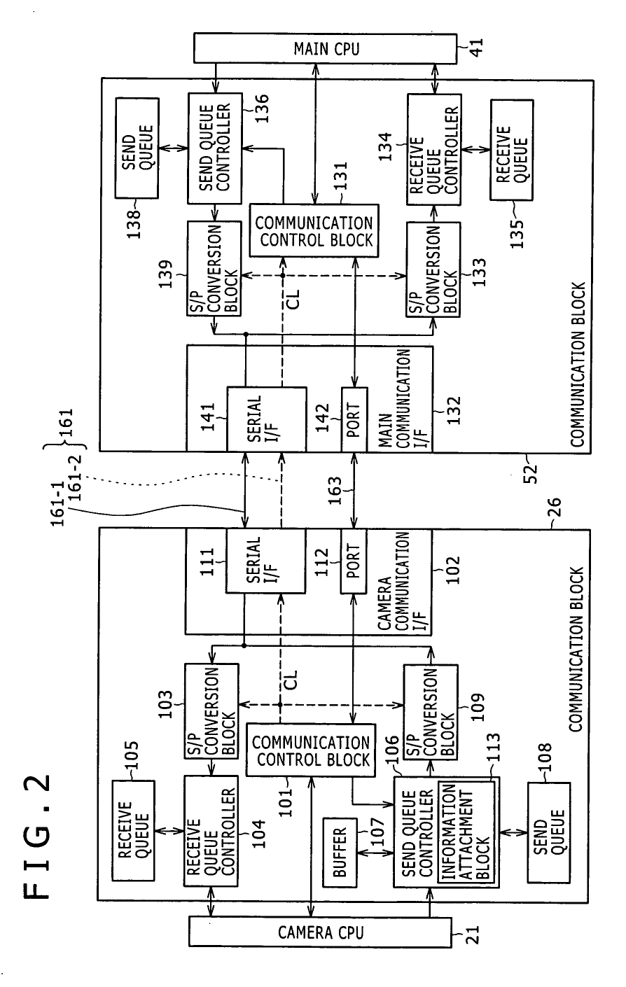

It should be noted that the communication block 26 of the camera block 11 and the communication block 52 of the recording/reproducing block 12 are interconnected with a communication bus 71 composed of a serial line 161 and a communication control line 163 (refer to FIG. 2), thereby mutually transferring various kinds of data as required.

The camera CPU 21 of the camera block 11 transfers data with the main CPU 41 of the recording/reproducing block 12 through serial communication via the communication block 26, the communication bus 71, and the communication block 52 under the control of the main CPU 41 of the recording/reproducing block 12. The camera CPU 21 receives commands from the main CPU 41 of the recording/reproducing block 12 via the communication block 52, the communication bus 71, and the communication block 26, thereby accordingly controlling the components of the camera block 11.

For example, in accordance with commands received from the main CPU 41, the camera CPU 21 controls the imaging block 22 to take an image of a subject. The camera CPU 21 supplies, to the buffer 23, an image (of data thereof) of a subject supplied from the imaging block 22 as a result of an imaging operation. Also, in accordance with commands from the main CPU 41, the camera CPU 21 reads image data from the buffer 23 and executes JPEG (Joint Photographic Experts Group) encoding on the read image data. Then, the camera CPU 21 transmits the encoded image data to the main CPU 41.

Further, in accordance with commands given by the main CPU 41, the camera CPU 21 stores the image data received from the main CPU 41 into the buffer 23 and, in accordance with commands given by the main CPU 41, reads the image data from the buffer 23 and supplies the image data to the display block 24 and reads, from the NVRAM 25, image data such as icon images, background images, and counter images (hereafter referred to as fixed image data) that is high in possibility of being displayed on the display block 24 two or more times, supplying the fixed image data to the display block 24.

It should be noted that the display on the display block 24 has layer structures by type such as background image layer, photograph image layer, and icon image layer, for example, each layer being independently configured to allow selection between display and non-display. The buffer 23 is made up of a buffer of each layer.

The imaging block 22, made up of an imaging device such as CMOS (Complementary Metal Oxide Semiconductor) or CCD (Charge Coupled Device) and an AF (Auto Focus) module, focuses a subject, takes an image of the focused subject, and supplies the taken image (data) to the camera CPU 21. The buffer 23 temporarily stores the image data supplied from the camera CPU 21. The display block 24, made up of a liquid crystal display for example, displays an image corresponding to the image data received from the camera CPU 21.

The NVRAM 25 is a rewritable memory and stores fixed image data. It should be noted that the fixed image data stored in the NVRAM 25 is rewritten by the camera CPU 21 in accordance with commands given by the main CPU 41.

The communication block 26 transmits and receives communication control signals with the communication block 52 of the recording/reproducing block 12 via the communication bus 71 under the control of the camera CPU 21, thereby transmitting and receiving various kinds of data by serial communication.

The power supply circuit 27 is connected to the power supply block 50 of the recording/reproducing block 12 via a power supply line 72. The power supply circuit 27 is supplied with power from the power supply block 50 via the power supply line 72. The power supply circuit 27 supplies the power supplied from the power supply block 50 to the components of the camera block 11 under the control of the camera CPU 21.

The main CPU 41 of the recording/reproducing block 12 writes or reads image and music data with the disc 60, executes various computations, and controls components for music reproduction under the control of an operation signal given from the operator block 42, for example. The main CPU 41 also generates commands for controlling components of the camera block 11 and transmits the generated commands to the camera CPU 21 of the camera block 11 via the communication block 52, the communication bus 71, and the communication block 26 under the control of an operation signal given from the operator block 42. Namely, the communication between the recording/reproducing block 12 and the camera block 11 is also controlled by the main CPU 41.

The operator block 42, composed of buttons and dials arranged on the surface of the recording/reproducing apparatus 1 for example, receives user instructions for the recording/reproducing apparatus 1, such as imaging, image displaying, or music reproduction, and supplies the operation signals representing these instructions to the main CPU 41. The USB I/F 43 supplies the image and music data from the recording/reproducing block 48 to the PC 2 via the USB cable 3 under the control of the main CPU 41. The USB I/F 43 is supplied with downloaded image and music data for example. The USB I/F 43 supplies the received data to the recording/reproducing block 48.

The audio signal processing block 44 executes 1-7 RLL (1-7 Run Length Limited coding) modulation processing for example on music data supplied from the main CPU 41 and supplies the processed music data to the recording/reproducing block 48. Also, the audio signal processing block 44 executes 1-7 RLL demodulation processing on the music data supplied from the recording/reproducing block 48 and supplies the processed music data to the audio input/output block 45.

The audio input/output block 45 supplies sound corresponding to the music data received from the audio signal processing block 44 to the speaker 46. Also, the audio input/output block 45 supplies sound supplied from the microphone 47 to the audio signal processing block 44. The speaker 46 sounds an audio signal received from the audio input/output block 45. The microphone 47 picks up sound and supplies it to the audio input/output block 45.

The recording/reproducing block 48 supplies image and music data read from the disc 60 to the buffer 49 and reads image and music data from the buffer 49 under the control of the main CPU 41. It should be noted that the disc 60 may include an optical disc (such as CD (Compact Disc) and DVD (Digital Versatile Disc), a magneto-optical disc (such as MD (Mini-Disc) and Hi-Mini-Disc), and a magnetic disc, for example.

The recording/reproducing block 48 supplies music data read from the buffer 49 to the audio signal processing block 44 and records music data supplied from the audio signal processing block 44 to the disc 60. In addition, the recording/reproducing block 48 supplies the image data read from the buffer 49 to the main CPU 41 and records to image data supplied from the main CPU 41 to the disc 60.

The buffer 49 stores the image and music data read from the disc 60 that are supplied from the recording/reproducing block 48.

The power supply block 50 supplies power to each component of the recording/reproducing block 12 in accordance with an operation status of the recording/reproducing block 12 under the control of the main CPU 41 and supplies power to the power supply circuit 27 of the camera block 11 via the power supply line 72 under the control of the main CPU 41.

The storage block 51 stores information (hereafter referred to as fixed image data associated information) associated with fixed image data stored in the NVRAM 25, for example. The main CPU 41 reads the fixed image data associated information from the storage block 51 and, on the basis of this fixed image data associated information, transmits image display commands to the camera CPU 21 via the communication block 52, the communication bus 71, and the communication block 26.

The communication block 52 transmits and receives communication control signals with the communication block 26 of the camera block 11 via the communication bus 71 under the control of the main CPU 41, thereby transmitting and receiving various kinds of data by serial communication.

In the recording/reproducing apparatus 1 configured as described above, the main CPU 41 controls the entire recording/reproducing apparatus 1 and the communication. Namely, in accordance with operation signals supplied from the operator block 42, the main CPU 41 controls each component of the recording/reproducing block 12 and generates commands for controlling each block of the camera block 11, transmitting the generated commands to the camera CPU 21 of the camera block 11.

Consequently, in the recording/reproducing apparatus 1, in accordance with commands supplied from the main CPU 41 via the communication bus 71, the camera CPU 21 displays an image corresponding to fixed image data stored in the NVRAM 25 onto the display block 24 and displays an image corresponding to image data supplied from the main CPU 41 onto the display block 24. On the other hand, the camera CPU 21 transmits image data obtained as a result of imaging to the main CPU 41 to record the image data on the disc 60 in accordance with commands given by the main CPU 41. Further, the main CPU 41 sounds, through the speaker 46, an audio signal representative of the music data recorded to the disc 60.

Referring to FIG. 2, there is shown a detail exemplary configuration of the communication block 26 of the camera block 11 and the communication block 52 of the recording/reproducing block 12.

The communication block 26 of the camera block 11 is composed of a communication control block 101, a camera communication I/F 102, an S/P (Serial/Parallel) conversion block 103, a receive queue controller 104, a receive queue 105, a send queue controller 106, a buffer 107, a send queue 108, and a P/S (Parallel/Serial) conversion block 109.

The communication block 52 of the recording/reproducing block 12 is composed of a communication control block 131, a main communication I/F 132, an S/P conversion block 133, a receive queue controller 134, a receive queue 135, a send queue controller 136, a send queue 138, and a P/S conversion block 139.

The communication block 26 of the camera block 11 and the communication block 52 of the recording/reproducing block 12 are interconnected via the camera communication I/F 102 and the main communication I/F 132 respectively, thereby transmitting and receiving various kinds of data. To be more specific, the camera communication I/F 102 is composed of a serial I/F 111 and a port 112 and the main communication I/F 132 of the recording/reproducing block 12 is composed of a serial I/F 141 and a port 142, thereby transmitting and receiving data, clock, and control signal between the camera block 11 and the recording/reproducing block 12.

The serial I/F 111 and the serial I/F 141 are interconnected with a serial line 161 composed of a serial data line 161-1 and a serial clock line 161-2. The serial I/F 111 and the serial I/F 141 transmit and receive packetized data (hereafter referred to as a packet) from the P/S conversion block 109 and the P/S conversion block 139 respectively via the serial data line 161-1. The serial I/F 111 supplies a clock signal received from the communication control block 101 to the serial I/F 141 via the serial clock line 161-2.

The port 112 and the port 142 are interconnected via the 8-line communication control line 163, transmitting and receiving various control signals with the communication control block 101 and the communication control block 131.

When a packet (a command packet for controlling the camera block 11) supplied from the recording/reproducing block 12 has been received from the receive queue controller 104, the camera CPU 21 of the camera block 11 shown in FIG. 2 acquires the free space information of the receive queue 105 from the receive queue controller 104 and determines, on the basis of the obtained free space information whether the receive queue 105 has a free space enough for receiving next data.

If the enough free space is found in the receive queue 105, the camera CPU 21 generates a command ACK packet obtained by packetizing the data for telling command reception completion and supplies the generated command ACK packet to the send queue controller 106, thereby requesting the communication control block 101 for the transmission of the command ACK packet. Namely, a command ACK packet is a packet indicative that a next command is receivable.

The camera CPU 21 also controls components of the camera block 11 in accordance with supplied commands, generates a result packet obtained by packetizing the data for telling the completion of execution of each command upon completion of execution thereof, and supplies the generated result packet to the send queue controller 106, thereby requesting the communication control block 101 for the transmission of the result packet. It should be noted that, if data is involved in command execution completion, a result data packet is also generated along with a result packet, the former being supplied to the send queue controller 106 immediately after the latter.

In accordance with a packet (a command packet or a result packet) send request a packet receive acknowledgement from the camera CPU 21, the communication control block 101 transmits and receives various control signals with the communication control block 131 of the recording/reproducing block 12 via the port 112. Under the control of the communication control block 131, the communication control block 101 supplies a predetermined clock generated by an incorporated clock generator (not shown) to the recording/reproducing block 12 via the serial I/F 111, thereby controlling the send queue controller 106 in synchronization with the clock to transmit packets accumulated in the buffer 107 or the send queue 108 to the recording/reproducing block 12. At this moment, the clock is also supplied to the S/P conversion block 103 and the P/S conversion block 109.

It should be noted that, under the control of the camera CPU 21, the communication control block 101 controls the send queue controller 106 such that, of the packets to be transmitted from the camera block 11, a command ACK packet will be transmitted in preference to a result packet.

In synchronization with the clock supplied from the communication control block 101, the S/P conversion block 103 S/P-converts the packet received from the serial I/F 111 and supplies the converted packet to the receive queue controller 104.

The receive queue controller 104 accumulates packets received from the S/P conversion block 103 into the receive queue 105 and, under the control of the camera CPU 21, supplies the packets in the receive queue 105 to the camera CPU 21. Also, in response to a request by the camera CPU 21, the receive queue controller 104 transmits the free space information of the receive queue 105 to the camera CPU 21.

When a command ACK packet has been supplied from the camera CPU 21, the send queue controller 106 accumulates the received command ACK packet in the buffer 107 and, when a result packet has been supplied from the camera CPU 21, accumulates the received result packet into the send queue 108. Namely, a command ACK packet is not accumulated in the send queue 108 because the command ACK packet is transmitted in preference to a result packet. The send queue controller 106 incorporates an information attachment block 113. The information attachment block 113 stores a total capacity of the send queue 108 to monitor the free space thereof.

In response to a send request from the communication control block 101, the send queue controller 106 reads the command ACK packet from the buffer 107 or the result packet from the send queue 108 and controls the information attachment block 113 to attach the total capacity and free space information (hereafter referred to as send queue information) of the send queue 108 to the read packet, thereby supplying the packet and information to the P/S conversion block 109.

The P/S conversion block 109 P/S-converts the packet received from the send queue controller 106 in synchronization with the clock supplied from the communication control block 101 and supplies the converted packet to the serial I/F 111.

The main CPU 41 of the recording/reproducing block 12 shown in FIG. 2 holds the total capacity and free space information of the send queue 108 of the camera block 11. The main CPU 41 executes parity check and packet analysis of the packet supplied from the receive queue controller 134 and, upon acquiring the send queue information attached to the packet, updates the total capacity and free space information of the send queue 108.

In accordance with a user instruction entered through the operator block 42, the main CPU 41 generates a command packet obtained by packetizing a command for predetermined processing, supplies the generated command packet to the send queue controller 136, and controls the communication control block 131 such that the send processing of the command packet will be executed before the send processing of the packet supplied from the camera block 11.

However, the main CPU 41 determines whether a command ACK packet for the previously transmitted command has already been received and keeps the command transmission in a wait status (or prohibits the command transmission) until the command ACK packet is found received. Namely, in this case, the main CPU 41 controls the communication control block 131 to prefer a packet send request from the camera CPU 21.

The main CPU 41 also determines whether the free space of the send queue 108 to be updated in accordance with the packet received from the camera block 11 is lower than a predetermined threshold. If the free space is found lower than a predetermined threshold, the main CPU 41 puts command transmission in a wait status, thereby controlling the communication control block 131 to prefer a packet send request from the camera CPU 21.

If the command ACK packet corresponding to the previously received command is found received and the free space of the send queue 108 is found greater than the predetermined threshold, then the main CPU 41 requests the communication control block 131 for the transmission of a command packet. It should be noted that if the command accompanies data, a command data packet is generated along with a command packet, both being supplied to the send queue controller 136 consecutively.

In accordance with a packet (or command packet) send request and a packet receive acknowledgement from the main CPU 41, the communication control block 131 transmits and receives control signals with the communication control block 101 of the camera block 11 via the port 142, thereby controlling the packet communication between the camera block 11 and the recording/reproducing block 12. At this moment, under the control of the main CPU 41, the communication control block 131 accepts a packet (or command packet) send request from the main CPU 41 in preference to a packet send request from the camera CPU 21 transmitted from the communication control block 101.

When the communication control block 131 transmits a packet send/receive acknowledge signal to the communication control block 101 of the camera block 11, the clock from the camera block 11 is supplied to the communication control block 131 and the S/P conversion block 133 and the P/S conversion block 139. Receiving the clock, the communication control block 131 causes the send queue controller 136 to transmit packets stored in the send queue 138 to the camera block 11 in synchronization with the clock.

In synchronization with the clock from the serial I/F 141, the S/P conversion block 133 S/P-converts the packet received from the serial I/F 141 and supplies the converted packet to the receive queue controller 134.

The receive queue controller 134 accumulates the data received from the S/P conversion block 133 into the receive queue 135 and, under the control of the main CPU 41, supplies the data from the receive queue 135 to the main CPU 41. Also, the receive queue controller 134 notifies the main CPU 41 of the free space of the receive queue 135 in response to a request from the main CPU 41.

When a command packet is supplied from the main CPU 41, the send queue controller 136 accumulates the received command packet into the send queue 138. In response to a request from the main CPU 41, the send queue controller 136 notifies the main CPU 41 of the free space information of the send queue 138. In response to a send request from the communication control block 101, the send queue controller 136 reads a command packet from the send queue 138 and supplies the command packet to the P/S conversion block 139.

In synchronization with the clock supplied from the communication control block 131, the P/S conversion block 139 P/S converts the data received from the send queue controller 136 and supplies the converted data to the serial I/F 141.

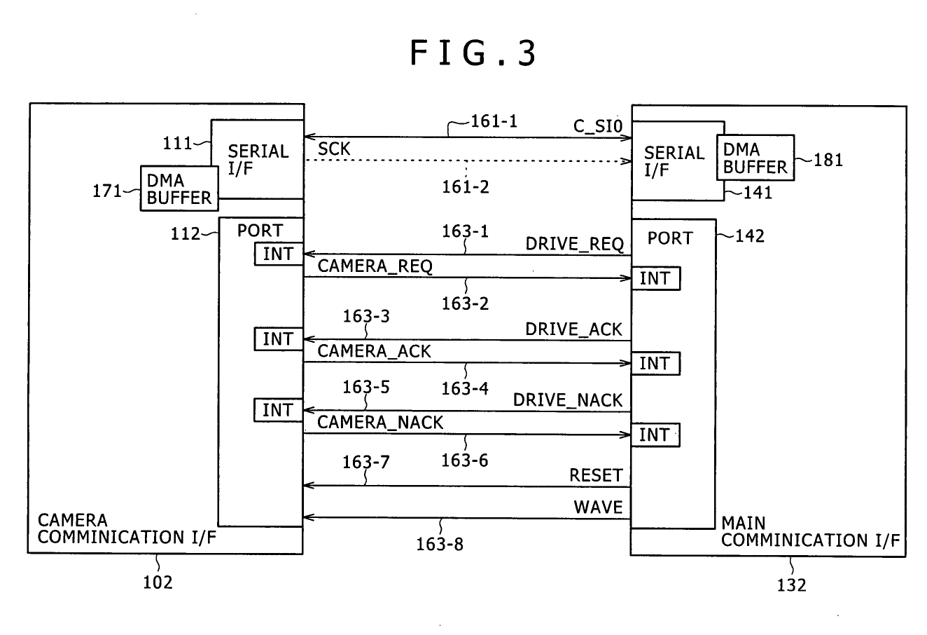

Referring to FIG. 3, there is shown detail exemplary configurations of the camera communication I/F 102 and the main communication I/F 132. It should be noted that, with reference to FIG. 3, components similar to those previously described with reference to FIG. 2 are denoted by the same reference numerals and omitted in description.

The camera communication I/F 102 is composed of the serial I/F 111, a DMA (Direct Memory Access) buffer 171, and the port 112. The main communication I/F 132 is composed of the serial I/F 141, a DMA buffer 181, and the port 142.

The serial I/F 111 of the camera block 11 and the serial I/F 141 of the recording/reproducing block 12 are interconnected via the serial data line (C_SIO) 161-1 and the serial clock line (SCK) 161-2 that are the serial line 161.

The serial I/F 111 transmits a predetermined clock supplied from the communication control block 101 to the serial I/F 141 via the serial clock line 161-2. The serial I/F 111 also executes serial communication with the serial I/F 141 via the serial data line 161-1 to supply data for serial communication to the DMA buffer 171 as required, thereby storing the data therein. As with the serial I/F 111, the serial I/F 141 supplies data for serial communication to the DMA buffer 181 as required, thereby storing the data therein.

The port 112 and the port 142 are interconnected via 8 communication control lines 163-1 through 163-8. The communication control line 163-1 transmits a REQ (Request) signal (or drive_REQ) from the main communication I/F 132 (or the port 142 thereof) to the camera communication I/F 102 (or the port 112 thereof), thereby executing an interrupt on the communication control block 101. The communication control line 163-2 transmits a REQ (Request) signal (or camera_REQ) from the port 112 to the main communication I/F 132 from the camera communication I/F 102, thereby executing an interrupt on the communication control block 131. The communication control block 101 and the communication control block 131 transmit REQ signals over the communication control line 163-1 or the communication control line 163-2 when requesting the establishment of serial communication by the serial line 161 for example under the control of the main CPU 41.

The communication control line 163-3 transmits an ACK (Acknowledge) signal (drive_ACK) from the main communication I/F 132 to the camera communication I/F 102, thereby causing an interrupt on the communication control block 101. The communication control line 163-4 transmits an ACK signal (camera_ACK) from the camera communication I/F 102 to the main communication I/F 132, thereby causing an interrupt on the communication control block 131.

The communication control line 163-5 transmits a NACK (Negative Acknowledgement) signal (drive NACK) from the main communication I/F 132 to the camera communication I/F 102, thereby causing an interrupt on the communication control block 101. The communication control line 163-6 transmits a NACK signal (camera_NACK) from the camera communication I/F 102 to the main communication I/F 132, there causing an interrupt on the communication control block 131.

Here, under the control of the camera CPU 21 or the main CPU 41, the communication control block 101 and the communication control block 131, upon normal reception of data from each other or when acknowledging a request sent from each other, transmit an ACK signal to each other and, upon abnormal reception of data from each other, transmit a NACK signal to each other.

The communication control line 163-7 transmits a RESET signal for initializing the camera CPU 21 from the main communication I/F 132 to the camera communication I/F 102 under the control of the main CPU 41. The communication control line 163-8 transmits a WAKE signal for starting the camera CPU 21 from the main communication I/F 132 to the camera CPU 21 via the camera communication I/F 102 under the control of the main CPU 41.

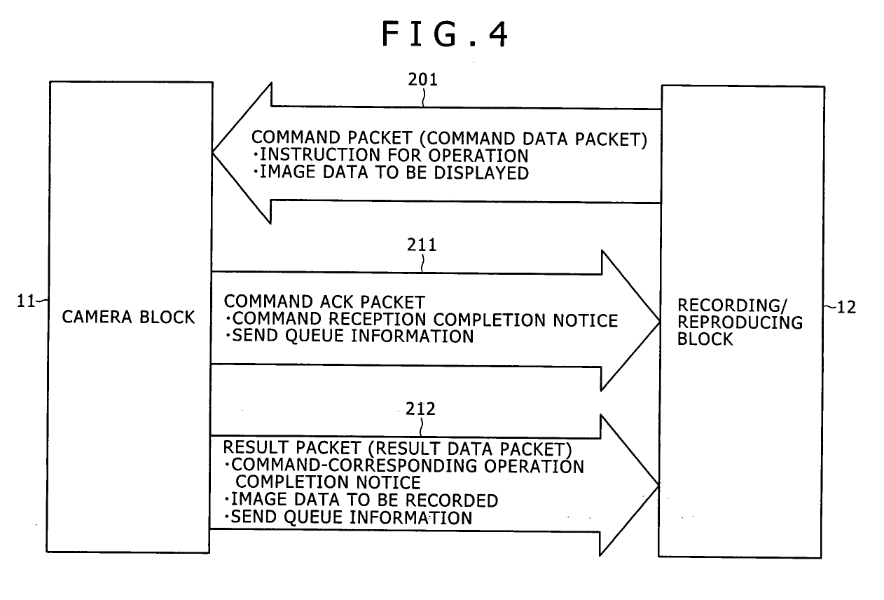

The following describes in detail data to be transmitted and received between the camera block 11 and the recording/reproducing block 12 with reference to FIG. 4.

The main CPU 41 of the recording/reproducing block 12 transmits a command packet 201 obtained by packetizing a command for instructing the camera block 11 for an operation to the camera block 11 via the serial data line 161-1. At this moment, the main CPU 41 may transmit a command data packet obtained by packetizing predetermined data to the camera block 11 along with the command packet 201 as required.

To be more specific, the command packet 201 is transmitted from the main CPU 41 of the recording/reproducing block 12 to the camera CPU 21 of the camera block 11 via the serial I/F 141, the serial line 161, and the serial I/F 111. The command packet 201 contains a command for giving an instruction by the main CPU 41 to the camera CPU 21.

The command packet 201 is transmitted along with a command data packet that contains data depending on the type of a command to be transmitted. For example, in the case of a command for displaying image data recorded to the disc 60 onto the display block 24 of the camera block 11, the image data to be displayed on the display block 24 is packetized to be transmitted immediately after the command packet 201 as a command data packet.

It should be noted that, if a command ACK packet 211 corresponding to the previously transmitted command packet 201 has not been received by the recording/reproducing block 12, the transmission of the command packet 201 is prohibited by the recording/reproducing block 12. Namely, in this case, in the recording/reproducing block 12, the reception of the command ACK packet 211 corresponding to the previously transmitted command packet 201 is prioritized.

The transmission of the command packet 201 is also prohibited if the free space of the send queue 108 is found lower than a predetermined threshold on the basis of the free space information of the send queue 108 of the camera block 11 attached to a command ACK packet 211 and a result packet 212 received from the camera block 11 (namely, if it is determined that the send queue 108 is kept in a wait status and a data overflow occurs in the send queue 108).

Namely, in this case, in the recording/reproducing block 12, the reception of a command ACK packet 211 and a result packet 212 are prioritized and therefore the communication route for these packets is freed. Namely, a command ACK packet (or a result packet) attached with send queue information may be a packet that requires to free the communication route for the transmission from the camera block 11 or tells whether to free the communication route.

Receiving the command packet 201 from the main CPU 41, the camera CPU 21 of the camera block 11 transmits a command ACK packet 211 obtained by packetizing the data for telling the completion of reception of the command packet 201 to the recording/reproducing block 12 via the serial data line 161-1.

To be more specific, a command ACK packet 211 is transmitted from the camera CPU 21 of the camera block 11 to the main CPU 41 of the recording/reproducing block 12 via the serial I/F 111, the serial data line 161-1, and the serial I/F 141. Each command ACK packet 211 is written with the completion of reception of the command packet 201 from the main CPU 41 and attached with the send queue information that is the information about the total capacity and free space of the send queue 108 of the camera block 11. It should be noted that this send queue information may only be the information that tells the free space of the send queue 108; namely, this information may be only the free space information of the send queue 108 or the information about both the total capacity and the accumulated data capacity.

One command ACK packet 211 is always generated for each command packet 201 and transmitted in preference to a result packet 212 if the receive queue 105 is ready for receiving a next command packet 201, namely the free space of the receive queue 105 is found greater than a predetermined threshold.

The camera CPU 21 of the camera block 11 executes an operation corresponding to the command of the command packet 201 received from the main CPU 41 and, after the completion of the operation, transmits a result packet 212 obtained by packetizing the result data for telling this completion to the recording/reproducing block 12 via the serial data line 161-1. At this moment, the camera CPU 21 may transmit a result data packet obtained by packetizing predetermined data to the recording/reproducing block 12 along with the result packet 212.

To be more specific, the result packet 212 is transmitted from the camera CPU 21 of the camera block 11 to the main CPU 41 of the recording/reproducing block 12 via the serial I/F 111, the serial data line 161-1, and the serial I/F 141. The result packet 212 has a notice telling the completion of the operation corresponding to the command packet 201 from the main CPU 41 and is attached with send queue information that is the information about the total capacity and free space of the send queue 108 of the camera block 11.

A result packet 212 is attached with a result data packet that includes data depending on the type of a received and completed command and this result packet 212 and this result data packet are transmitted. For example, in the case of a result corresponding to a command for controlling the imaging block 22 to enter the video of a subject and record the entered image data to the disc 60 of the recording/reproducing block 12, the image data entered from the imaging block 22 and recorded to the disc 60 is packetized to be consecutively transmitted after the result packet 212 as a result data packet.

A result packet 212 is lower in priority of transmission than a command ACK packet 211 in the camera block 11. Therefore, if a request for the transmission of a command ACK packet 211 is made before a result packet 212, then the result packet 212 is transmitted after the transmission of the command ACK packet 211.

It should be noted that a result packet 212 is not always generated for a command packet 201 on a one by one basis; namely, depending on the type of command, two or more result packets are generated or no result packet is generated. For example, for any command that infinitely executes something, no result packet 212 is generated.

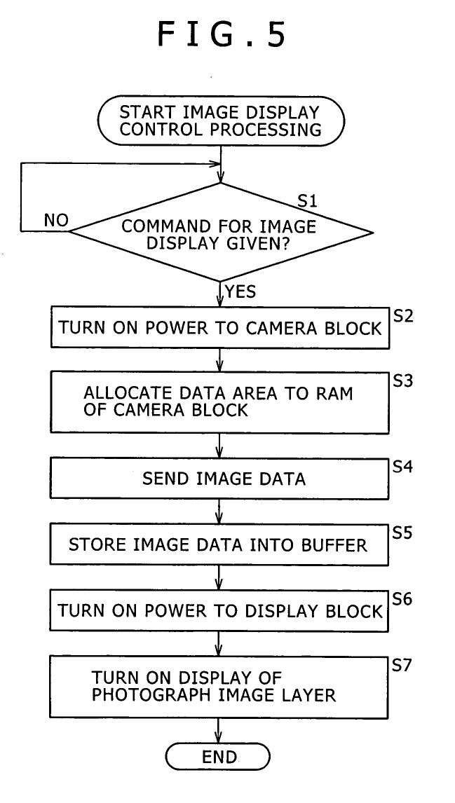

The following describes image display control processing of the recording/reproducing apparatus 1 with reference to the flowchart shown in FIG. 5.

The user operates the operator block 42 to give an instruction for displaying an image recorded to the disc 60. The operator block 42 accepts the user instruction and supplies an operation signal representative of the instruction to the main CPU 41.

In step S1, the main CPU 41 waits until an instruction for image display comes. When an operation signal is supplied from the operator block 42, then the main CPU 41 determines in step S1 that an instruction for image display has come, upon which the procedure goes to step S2 to turn on the power to the camera block 11.

Namely, the main CPU 41 supplies power to the power supply circuit 27 of the camera block 11 via the power supply line 72 and, at the same time, controls the communication control block 131 to transmit a WAKE signal for starting the camera CPU 21 via the communication control line 163-8 of the port 142. A WAKE signal is supplied to the camera CPU 21 via the port 112 and the communication control block 101. The camera CPU 21 starts in response to the WAKE signal and controls the power supply circuit 27 to supply power to predetermined components of the camera block 11.

Consequently, the power to the camera block 11 is turned on, upon which the camera CPU 21 controls the communication control block 101 to initialize all the communication control lines 163-2, 163-4, and 163-6 (camera_* * * ) of the port 112. The communication control block 131 recognizes that the communication control lines 163-2, 163-4, and 163-6 on the camera side have entered the initialized status and supplies this information to the main CPU 41.

The main CPU 41 recognizes the starting of the camera block 11 from the information that all the communication control lines 163-2, 163-4, and 163-6 have entered the initialized status. Then, the procedure goes to step S3, in which the main CPU 41 controls the camera CPU 21 to allocate a data area for storing the image data supplied from the disc 60 to a RAM (Random Access Memory), not shown, incorporated in the camera CPU 21.

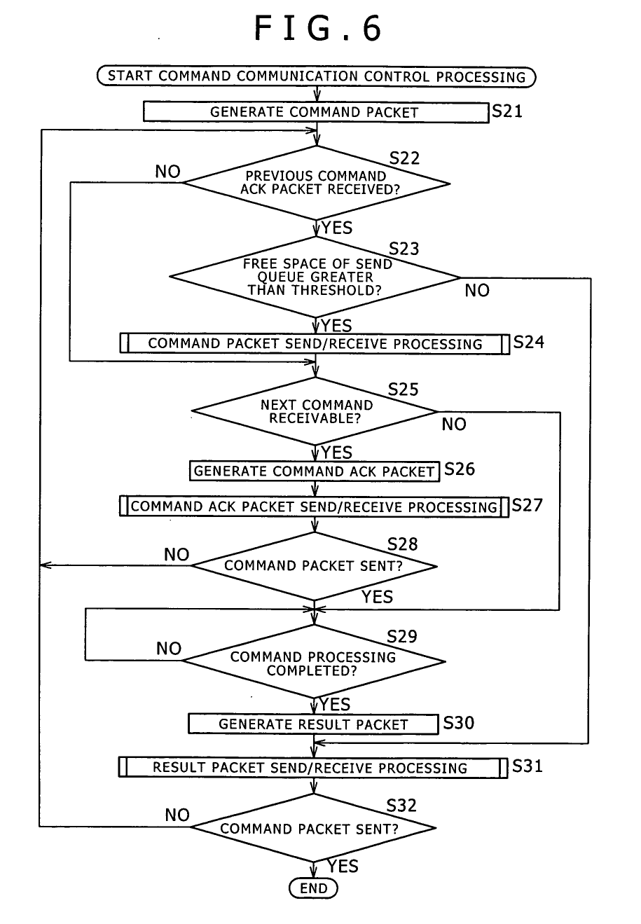

Namely, the main CPU 41 generates a command packet obtained by packetizing a command for allocating a data area for image data to the RAM incorporated in the camera CPU 21. In response, the main CPU 41 and the camera CPU 21 transmit and receive the generated command packet, execute the processing of the received command packet, and executes command communication control processing that is a process up to the completion of the command packet processing. This command communication control processing will be detailed later with reference to FIG. 6. It should be noted that the similar command communication control processing will be executed also in subsequent steps S4 through S7.

In this command communication control processing, the command packet generated by the main CPU 41 is transmitted from the recording/reproducing block 12 to the camera CPU 21 of the camera block 11. The camera CPU 21 transmits a command ACK packet corresponding to the received command packet and, at the same time, executes the command. When this command is executed, the data area for image data is allocated to the RAM in the camera CPU 21 of the camera block 11. Consequently, the camera CPU 21 recognizes the completion of command execution, thereby transmitting a result packet to the recording/reproducing block 12.

Receiving the result packet from the camera CPU 21, the main CPU 41 recognizes the completion of the command execution of step S3, upon which the procedure goes to step S4, in which the main CPU 41 controls the recording/reproducing block 48 to transmit the image data read from the disc 60 to the camera block 11.

Namely, the main CPU 41 causes the image data to be received by the camera CPU 21, thereby generating a command packet obtained by packetizing a command for storing the image data into the RAM incorporated in the camera CPU 21 of the camera block 11. In response, the main CPU 41 and the camera CPU 21 of the camera block 11 execute command communication control processing (FIG. 6).

In this command communication control processing, a command packet generated by the main CPU 41 and a command data packet including image data are transmitted from the recording/reproducing block 12 to the camera CPU 21 of the camera block 11. The camera CPU 21 transmits a command ACK packet corresponding to the received command packet and, at the same time, executes this command. When this command has been executed, the image data is received by the camera block 11 to be stored in the RAM of the camera CPU 21. Consequently, camera CPU 21 recognizes the completion of the command execution and transmits a result packet to the recording/reproducing block 12.

Receiving the result packet, the main CPU 41 recognizes the completion of the command execution of step S4, upon which the procedure goes to step S5, in which the main CPU 41 stores the image data from the RAM of the camera CPU 21 into the buffer 23 of the camera block 11. It should be noted that the display on the display block 24 has a layer structure by type, such as background image layer, photograph image layer, and icon image layer, these layers being independently selectable in display and non-display. The buffer 23 is based on a buffer dedicated to each layer.

Namely, for the camera CPU 21, the main CPU 41 generates a command packet obtained by packetizing a command for storing the image data in the RAM of the camera CPU 21 into a buffer for a predetermined layer (the photograph image layer) of the buffer 23 of the camera block 11. In response, the main CPU 41 and the camera CPU 21 of the camera block 11 execute the command communication control processing (FIG. 6).

In this command communication control processing, the command packet generated by the main CPU 41 is transmitted from the recording/reproducing block 12 to the camera CPU 21 of the camera block 11. The camera CPU 21 transmits a command ACK packet corresponding to the received command packet and, at the same time, executes the command. When the command has been executed, the image data in the RAM of the camera CPU 21 is stored in a buffer for the photograph image layer in the buffer 23 of the camera block 11. Consequently, the camera CPU 21 recognizes the completion of the command execution, thereby transmitting a result packet to the recording/reproducing block 12.

Receiving the result packet, the main CPU 41 recognizes the completion of the command execution of step S5, upon which the procedure goes to step S6, in which the main CPU 41 makes the camera CPU 21 to turn on the power of the display block 24 of the camera block 11.

Namely, for the camera CPU 21, the main CPU 41 generates a command packet obtained by packetizing a command for turning on the power to the display block 24 of the camera block 11. In response, the main CPU 41 and the camera CPU 21 of the camera block 11 execute the command communication control processing (FIG. 6).

In this command communication control processing, the command packet generated by the main CPU 41 is transmitted from the recording/reproducing block 12 to the camera CPU 21 of the camera block 11. The camera CPU 21 transmits a command ACK packet corresponding to the received command packet and, at the same time, executes the command. When the command has been executed, the power is supplied by the power supply circuit 27 of the camera block 11 to the display block 24 to turn on the power to the display block 24. Consequently, the camera CPU 21 recognizes the completion of the command execution, thereby transmitting a result packet to the recording/reproducing block 12.

Receiving the result packet, the main CPU 41 recognizes the completion of the command execution of step S6, upon which the procedure goes to step S7, in which the main CPU 41 turns on the photograph image layer forming the display on the display block 24, thereby displaying the image data from the buffer for the photograph image layer in the buffer 23 onto the photograph image layer.

Namely, the main CPU 41 controls the camera CPU 21 to turn on the photograph image layer forming the display on the display block 24 of the camera block 11, thereby generating a command packet obtained by packetizing a command for displaying image data from the buffer for the photograph image layer in the buffer 23 onto the photograph image layer. In response, the main CPU 41 and the camera CPU 21 of the camera block 11 execute the command communication control processing (FIG. 6).

In this command communication control processing, the command packet generated by the main CPU 41 is transmitted from the recording/reproducing block 12 to the camera CPU 21 of the camera block 11. The camera CPU 21 transmits a command ACK packet corresponding to the received command packet and, at the same time, executes the command. When the command has been executed, the photograph image layer forming the display on the display block 24 is turned on, upon which image data is read from the buffer for the photograph image layer in the buffer 23, an image corresponding to the image data being displayed on the photograph image layer. Consequently, the camera CPU 21 recognizes the completion of the command execution, thereby transmitting a result packet to the recording/reproducing block 12.

Receiving the result packet, the main CPU 41 recognizes that the image corresponding to the image data recorded to the disc 60 has been displayed on the photograph image layer on the display block 24 in the camera block 11, thereby ending the image display control processing.

Thus, the main CPU 41 of the recording/reproducing block 12 generates a command packet obtained by packetizing a command for executing the processing to be controlled for the camera CPU 21 of the camera block 11 and controls the camera block 11 to execute the processing corresponding to the generated command through command communication control processing.

It should be noted that, in the above description, an example is used in which the recording/reproducing block 12 receives a result packet and then transmits a next command packet, however, because the priority of the packet transmission from the recording/reproducing block 12 is high between the camera block 11 and the recording/reproducing block 12, the recording/reproducing block 12 may transmit a next command packet before the reception of a result packet in accordance with the contents of previous and next commands as long as a command ACK packet corresponding to the previous command has already been received and the free space of the send queue 108 of the camera block 11 is not small.

For example, in the case of a result corresponding to a command for recording image data entered from the imaging block 22 to the disc 60 of the recording/reproducing block 12, the image data entered from the imaging block 22 to be recorded to the disc 60 is transmitted consecutively after the result packet 212 as a result data packet. In such a case, the recording/reproducing block 12 may transmit the command packet 201 for controlling the imaging block 22 to enter a next image for example even before the result packet 212 is received as long as the command ACK packet 211 corresponding to a command for recording the image data entered from the imaging block 22 to the disc 60 of the recording/reproducing block 12 has already been received and the free space of the send queue 108 of the camera block 11 is not small.

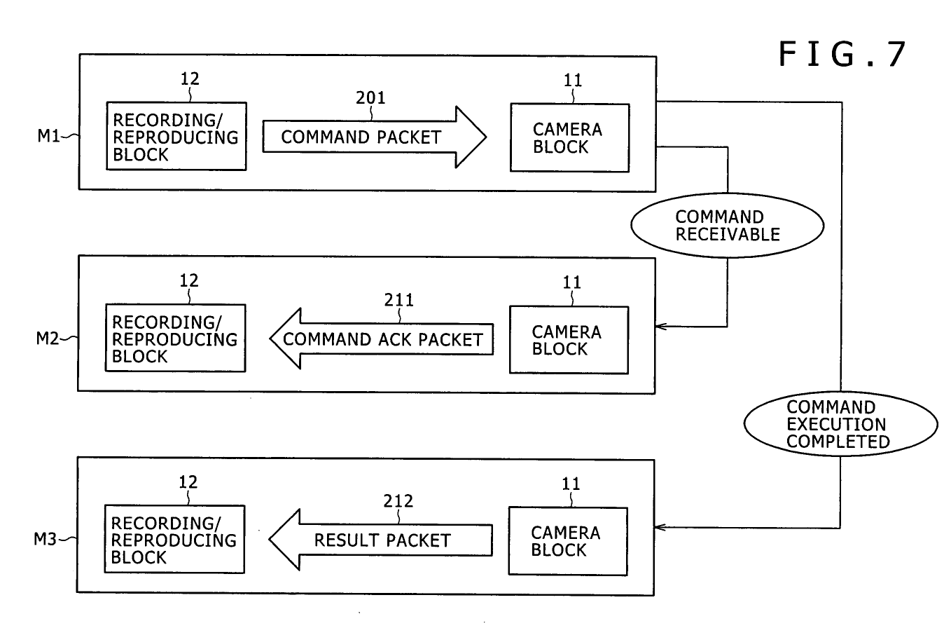

The following describes command communication control processing that is executed in steps S3 through S7 shown in FIG. 5, with reference to the flowchart shown in FIG. 6 and to FIG. 7. To be more specific, steps S3 through S7 shown in FIG. 5 are different from each other only in the processing contents of the command to be processed and generally the same in command communication control, so that these steps will be described as a whole with reference to FIG. 6.

It should be noted that, in the example shown in FIG. 6, so as to sequentially describe a sequence of command communication control processing operations for one command, processing operations to be executed by the camera block 11 and the recording/reproducing block 12 are shown in the sequence of communication control operations for the convenience of description. Namely, in the example shown in FIG. 6, steps S21 through S23, S28, and S32 execute the processing of the recording/reproducing block 12, steps S25, S26, S29, and S30 execute the processing of camera block 11, and steps S24, S27, and S31 execute the mutual processing of the camera block 11 and the recording/reproducing block 12.

In what follows, the processing operations of steps S21 through S23 are also generically referred to as command packet send preparation processing, the processing operations of steps S25 and S26 are also generically referred to as command ACK packet send preparation processing, and the processing operations of steps S29 and S30 are also generically referred to as result packet send preparation processing.

In step S21, the main CPU 41 of the recording/reproducing block 12 generates a command packet obtained by packetizing a predetermined command (for example, in the case of step S3 shown in FIG. 5, a command for making the camera CPU 21 receive image data to store the image data into a RAM in the camera CPU 21 of the camera block 11) and supplies the generated command packet to the send queue controller 136. In step S22, the main CPU 41 determines whether a command ACK packet corresponding to the previously transmitted command has been received.

In step S22, if the main CPU 41 determines that the command ACK packet corresponding to the previously transmitted command has not been received, then the procedure skips steps S23 and S24 and goes to step S25. Namely, in this case, the main CPU 41 does not make a command packet send request; if the camera CPU 21 makes a command ACK packet send request, the main CPU 41 accepts this request.

In other words, the main CPU 41 delays (or prohibits) the command packet transmission until the previous command ACK packet is transmitted from the camera block 11 and received by the main CPU 41 in step S27 to be described later. It should be noted that the command ACK packet is not one that corresponds to the current command packet but the previous command ACK packet corresponding to the previous command packet.

If the command ACK corresponding to the previously transmitted command is found received in step S22, then the main CPU 41 determines in step S23 whether the free space of the send queue 108 is greater than a predetermined threshold on the basis of the stored free space information of the send queue 108.

If the free space of the send queue 108 is found smaller than the predetermined threshold in step S23, then the processing operations of steps S24 through S30 are skipped because a result packet indicative of a result of the previous command processing is stored in the send queue 108. The procedure goes to step S31, in which the result packet is transmitted and received with priority. Namely, in this case, the main CPU 41 does not make a command packet send request but accepts a result packet send request made by the camera CPU 21.

In other words, the main CPU 41 delays (or prohibits) the transmission of the command packet until a previous result packet is transmitted from the camera block 11 and received by the main CPU 41 to determine that the free space of the send queue 108 is greater than the predetermined threshold.

It should be noted that, because the previous command ACK packet is determined received in step S22 at this moment, the processing operations associated with the command ACK packet of steps S25 through S27 are also skipped. If a command ACK packet is stored in the buffer 107 with the previous command ACK packet not received, the procedure goes to step S27, in which the command ACK packet is transmitted before a result packet is transmitted. The result packet in this case is not one that corresponds to the current command packet but corresponds to a previous command packet.

If the main CPU 41 determines in step S23 that the free space of the send queue 108 is greater than the predetermined threshold on the basis of the free space information of the send queue 108, then requests the communication control block 131 to send the command packet 201.

In response, in step S24, the communication control block 131 of the recording/reproducing block 12 and the communication control block 101 of the camera block 11 execute command packet send/receive control processing Ml shown in FIG. 7 under the control of the main CPU 41 and the camera CPU 21.

In command packet send/receive control processing M1, the communication control block 131 of the recording/reproducing block 12 transmits command packet 201 via the serial data line 161-1 under the control of the main CPU 41 and the communication control block 101 receives the command packet 201 from the recording/reproducing block 12 under the control of the camera CPU 21.

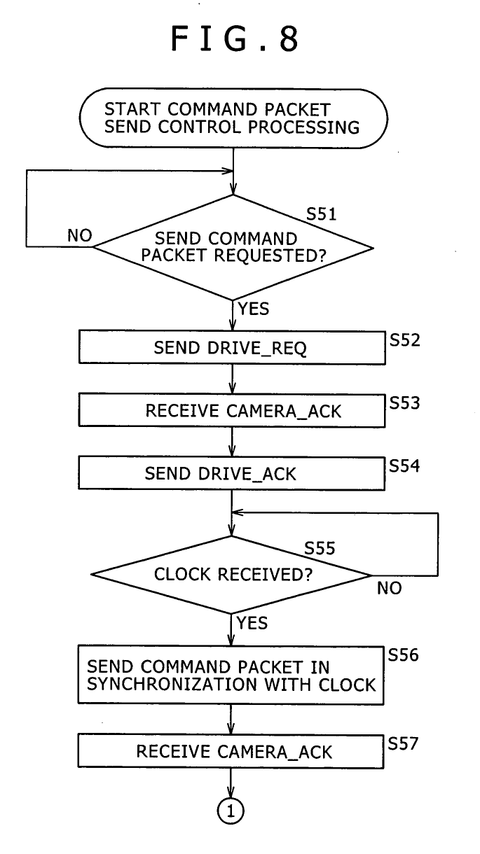

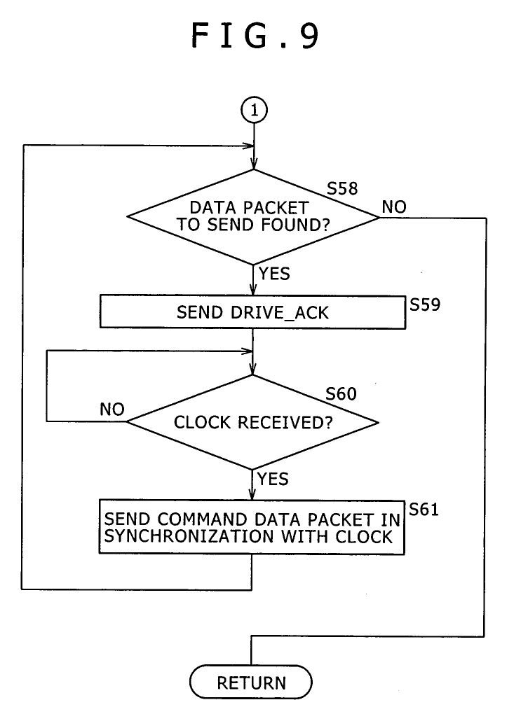

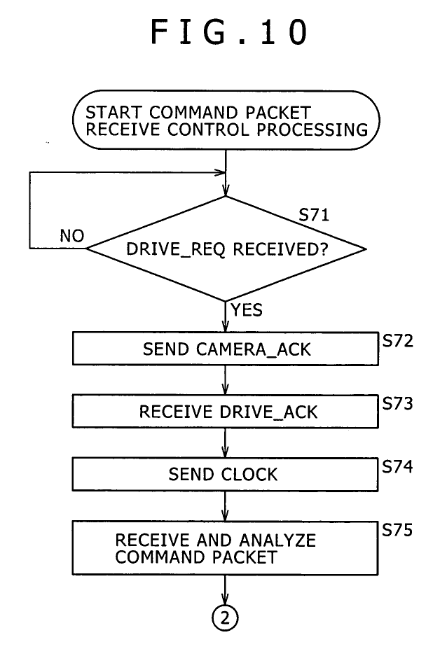

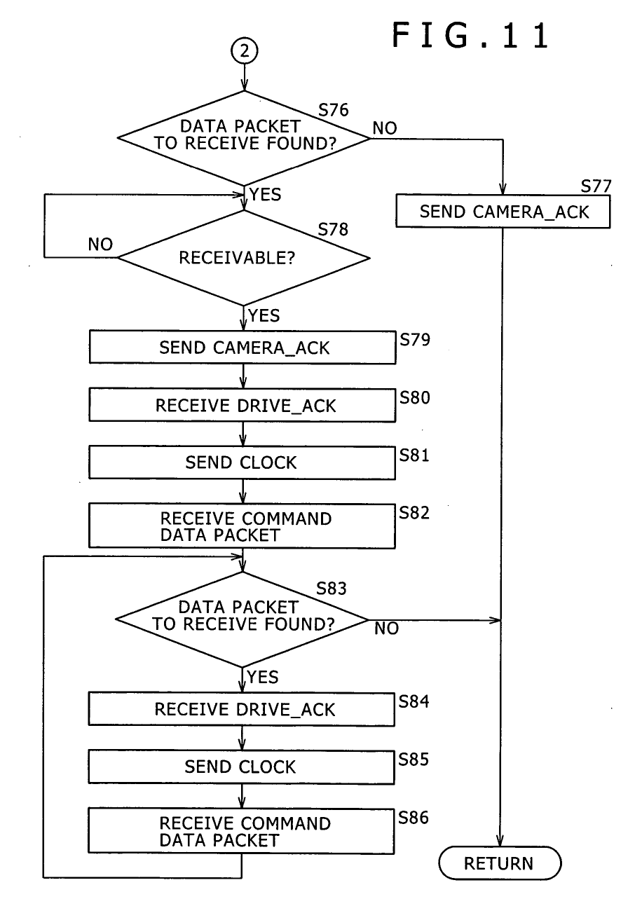

The command packet send control processing by the communication control block 131 of the recording/reproducing block 12 will be detailed with reference to FIGS. 8 and 9 and the corresponding command packet receive control processing by the communication control block 101 of the camera block 11 will be detailed with reference to FIGS. 10 and 11.

By the command packet send/receive control processing of step S24, the camera CPU 21 of the camera block 11 receives the command packet 201 from the recording/reproducing block 12. The camera CPU 21 executes parity check on the command packet 201 to analyze the command packet 201, recognizes the completion of the reception of the command packet 201, and executes the command processing of the command packet 201. Then the procedure goes to step S25.

In step S25, if the camera CPU 21 acquires the free space information of the receive queue 105 from the receive queue controller 104 to determine whether the free space of the receive queue 105 is greater than a predetermined threshold, thereby determining whether a next command packet is receivable.

If the free space of the receive queue 105 is found smaller than the predetermined threshold in step S25, then the processing operations of steps S26 through S28 are skipped. In step S29, the camera CPU 21 starts result packet send preparation processing. The result packet in this case is not one that corresponds to the current command packet but corresponds to a previous command packet.

Namely, the camera CPU 21 determines that a next command packet cannot be received until the command of the command packet stored in the receive queue 105 has been executed and completed and the free space of the command packet stored in the receive queue 105 is found greater than the predetermined threshold, thereby delaying (or prohibiting) the transmission of a command ACK packet. Therefore, if a result packet is generated in step S30 to be described later because the command has been executed and completed during the delay, result packet send/receive processing of step S31 to be described later is preferentially executed.

If the free space of the receive queue 105 is found greater than the predetermined threshold in step S25, then the next command packet is receivable. Then, in step S26, the camera CPU 21 generates the command ACK packet 211 indicative of the completion of the reception of the command packet 201 completed in reception and supplies the generated packet to the send queue controller 106, thereby requesting the communication control block 101 for the transmission of the command ACK packet 211.

In response, the communication control block 101 of the camera block 11 and the communication control block 131 of the recording/reproducing block 12 execute command ACK packet send/receive control processing M2 shown in FIG. 7 under the control of the camera CPU 21 and the main CPU 41 in step S27.

In command ACK packet send/receive control processing M2, the communication control block 101 of the camera block 11 transmits the command ACK packet 211 via the serial data line 161-1 under the control of the camera CPU 21 and the communication control block 131 of the recording/reproducing block 12 receives the command ACK packet 211 from the camera block 11 under the control of the main CPU 41.

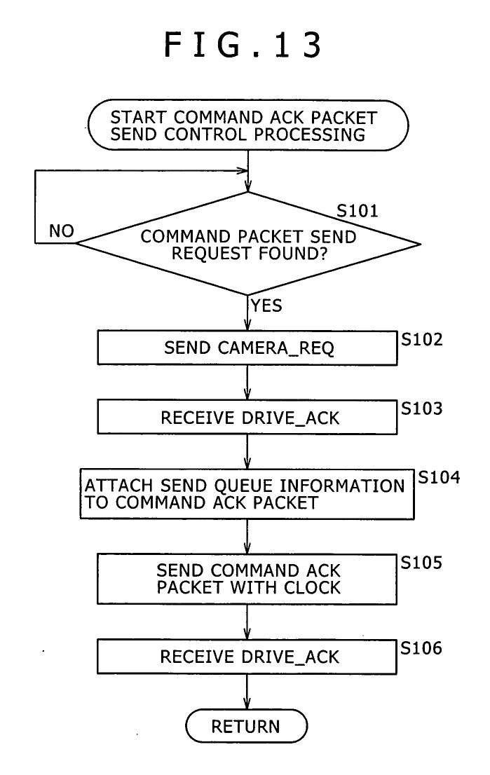

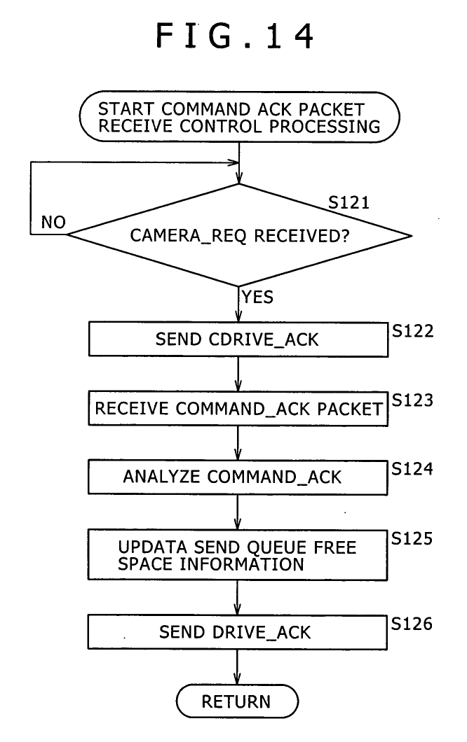

The command ACK packet send control processing by the communication control block 101 of the camera block 11 will be detailed with reference to FIG. 13 and the command ACK packet receive control processing by the communication control block 131 of the recording/reproducing block 12 will be detailed with reference to FIG. 14.

By this command ACK packet send/receive control processing, a command ACK packet corresponding to the transmitted command is received in the recording/reproducing block 12 and the free space information of the send queue 108 of the main CPU 41 is updated on the basis of send queue information attached to the command ACK packet.

Receiving the command ACK packet, the main CPU 41 of the recording/reproducing block 12 determines in step S28 whether the command packet generated in step S21 has been transmitted. If the generated command packet is found not yet transmitted, then the procedure returns to step S22 to repeat the above-mentioned processing operations therefrom. Namely, in step S27 where the generated command packet is found not yet transmitted, the command ACK packet corresponding to the previous command is transmitted and received.

If the main CPU 41 of the recording/reproducing block 12 determines that the command packet has been transmitted in step S28, the main CPU 41 may start the preparations (or the processing operations of steps S21 through S23) for the transmission of a next command packet 201 because the received command ACK packet corresponds to the command packet generated in step S21, thereby recognizing that the next command is transmittable.

On the other hand, in the camera block 11, the command in the command packet 201 has been executed concurrently with the command ACK packet send/receive control processing of step S27. When the command ACK packet send/receive control processing of step S27 has been completed, the camera CPU 21 determines in step S29 whether the execution of the command in the command packet 201 has been completed. The camera CPU 21 waits until the execution of the command in the command packet 201 comes to an end.

If the camera CPU 21 determines in step S29 that the execution of the command in the command packet 201 has been completed, then the camera CPU 21 generates a result packet 212 indicative of the completion of the execution of the command packet 201 in step S30 and supplies the generated result packet to the send queue controller 106, at the same time requesting the communication control block 101 for the transmission of the result packet 212.

In response, the communication control block 101 of the camera block 11 and the communication control block 131 of the recording/reproducing block 12 execute result packet send/receive control processing M3 shown in FIG. 7 under the control of the camera CPU 21 and the main CPU 41 in step S31.

In result packet send/receive control processing M3, the communication control block 101 of the camera block 11 transmits a result packet 212 via the serial data line 161-1 under the control of the camera CPU 21 and the communication control block 131 receives the result packet 212 from the camera block 11 under the control of the main CPU 41.

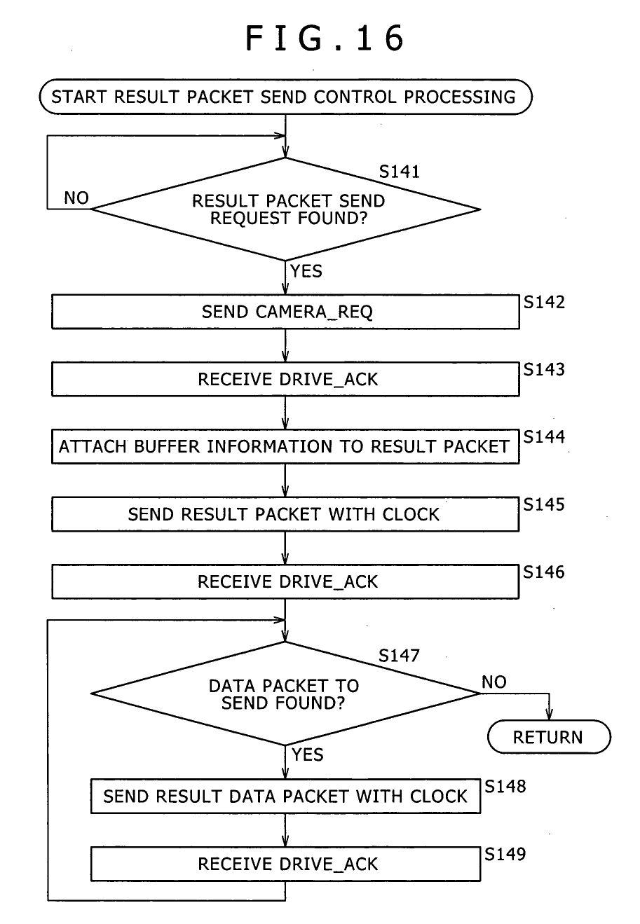

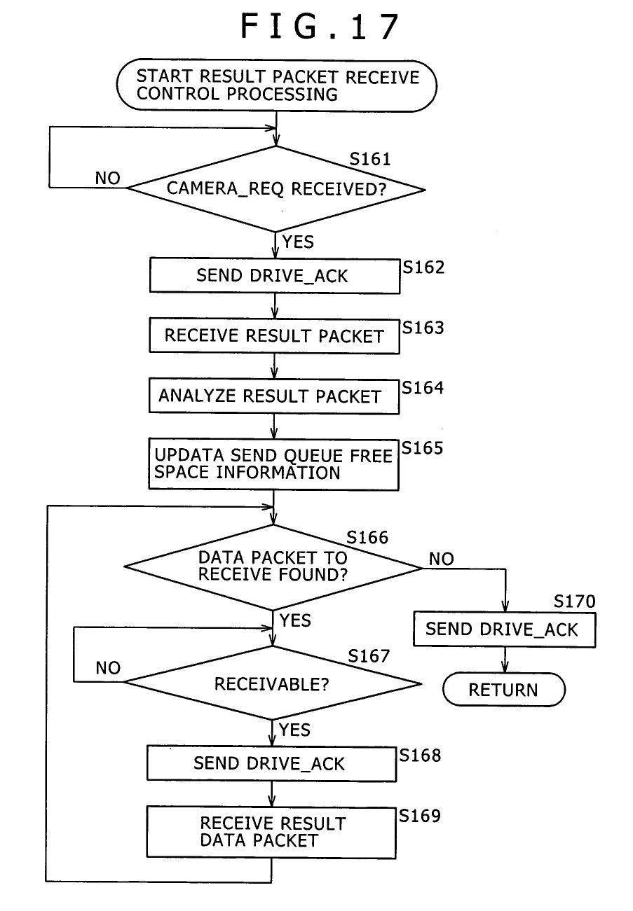

The result packet send control processing by the communication control block 101 of the camera block 11 will be detailed with reference to FIG. 16 and the result packet receive control processing by the communication control block 131 of the recording/reproducing block 12 will be detailed with reference to FIG. 17.

By this result packet receive control processing, the result packet is transmitted in the camera block 11, so that the number of result packets stored in the send queue 108 of the camera block 11 decreases to increase the free space of the send queue 108. In the recording/reproducing block 12, the result packet corresponding to the previously transmitted command is received and, on the basis of the send queue information attached to the received result packet, the free space of the send queue 108 of the main CPU 41 is updated.

By the processing of step S31, the main CPU 41 of the recording/reproducing block 12 that has received the result packet determines in step S32 whether the command packet generated in step S21 has been transmitted. If the generated command packet is found not yet transmitted, the procedure returns to step S22 to repeat the above-mentioned processing therefrom. Namely, in the processing of step S31 where the generated command packet is found not yet transmitted, the result packet corresponding to a previous command is transmitted and received.

If the main CPU 41 of the recording/reproducing block 12 determines in step S32 that the command packet has been transmitted, the communication control processing for this command comes to an end.

It should be noted that no result packet is generated for some commands depending on the contents of commands to be transmitted and received. In this case, the processing operations of steps S29 through S31 of the above-mentioned processing shown in FIG. 6 are skipped.

Thus, in the command communication between the recording/reproducing block 12 and the camera block 11, the command transmission of the recording/reproducing block 12 that controls the entire recording/reproducing apparatus 1 is prioritized. However, each packet (result packet or command ACK packet) to be transmitted from the camera block 11 is attached with the free space information of the send queue 108 of the camera block 11 before transmission, so that the recording/reproducing block 12 that execute control in the command communication may acquire the information about the status of the send queue 108 of the camera block 11. Consequently, if the free space of the send queue 108 exceeds a predetermined threshold, the packet transmission from the camera block 11 can be preferred to the packet transmission from the recording/reproducing block 12.

The preference of the packet transmission from the camera block 11 may prevent the send queue 108 from overflowing due to the retention of packets on the side of the camera block 11. This in turn may prevent the control of command communication from becoming difficult.

In addition, the camera block 11 transmits a command ACK packet indicative that the reception of a command corresponding to a command packet one to one has been completed and a next command is ready to receive and the recording/reproducing block 12 cannot transmit a next command packet unless a command ACK packet corresponding to the transmitted packet is received. This configuration prevents the camera block 11 from receiving too many command packets (thereby causing an overflow in the receive queue 105).

Further, this command ACK packet is also attached with the free space information of the send queue 108 of the camera block 11. Therefore, if a result packet has not been received for long in such a situation as the delayed completion of command execution for example, a command ACK packet is transmitted and received for each command, thereby enabling the recording/reproducing block 12 that executes control in command communication to acquire the information about the status of the send queue 108 of the camera block 11 from time to time.

Namely, in the recording/reproducing block 12, the status of the send queue 108 of the camera block 11 may be known from time to time, so that the control of command communication is prevented from becoming difficult if the process (or the processing being executed) of the status change of the camera block 11 is not always maintained.

As described above, controlling only the main CPU 41 of the recording/reproducing block 12 in the command communication between the recording/reproducing block 12 and the camera block 11 allows comfortable communication.

In addition, if command specifications are modified, only the recording/reproducing block 12 that controls the entire recording/reproducing apparatus 1 (including the control of command communication) may be accordingly modified, thereby saving the modification of the camera block 11.

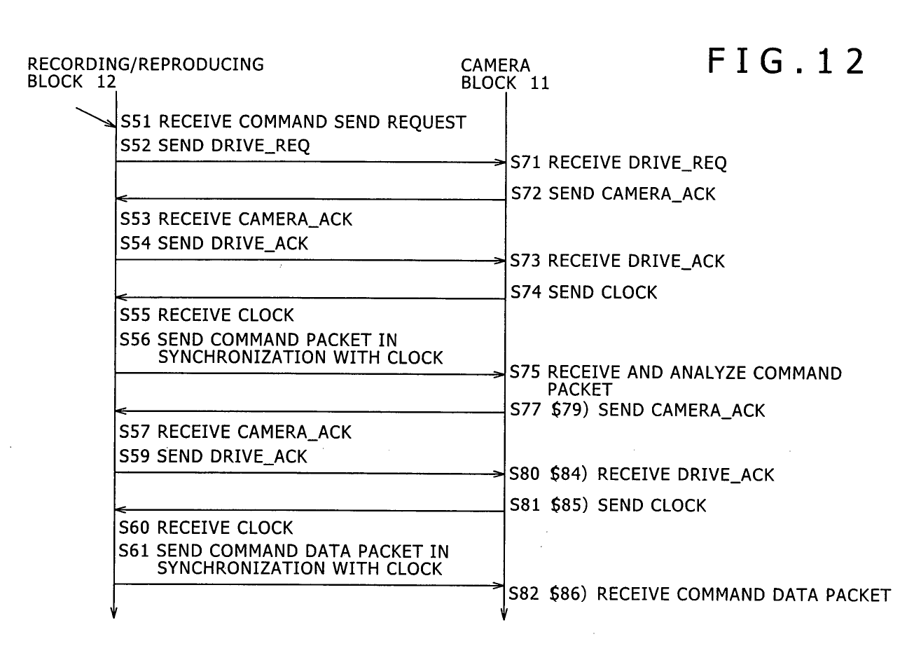

The following describes the command packet send/receive control processing of step S24 shown in FIG. 6 with reference to the flowcharts shown in FIG. 8 through 11 and the arrow chart shown in FIG. 12. FIGS. 8 and 9 show the command packet send control processing of the recording/reproducing block 12 and FIGS. 10 and 11 show the command packet receive control processing of the camera block 11. FIG. 12 shows a relationship between the processing by the recording/reproducing block 12 and the processing by the camera block 11.

In what follows, the processing operations by the recording/reproducing block 12 and the camera block 11 are individually described with reference to FIGS. 8 through 11. The relationship in processing between these blocks may easily be understood with reference of the corresponding steps shown in FIG. 12. It should be noted that, in FIG. 12, those steps which are not directly associated with the processing to be mutually executed by the recording/reproducing block 12 and the camera block 11 are appropriately skipped.

First, the command packet send control processing of the recording/reproducing block 12 will be described with reference to the flowcharts shown in FIGS. 8 and 9.

In step S51, the communication control block 131 of the recording/reproducing block 12 waits until requested by the main CPU 41 for the transmission of a command packet. When a command packet transmission request is found received from the main CPU 41, then the procedure goes to step S52, in which the communication control block 131 transmits a REQ signal (drive_REQ) to the camera block 11 via the communication control line 163-1 of the port 142.

Receiving the REQ signal (drive_REQ) via the communication control line 163-1 and the port 112, the camera block 11 returns an ACK signal (camera_ACK) via the port 112 and the communication control line 163-4 (step S72 shown in FIGS. 10 and 12).

In step S53, the communication control block 131 of the recording/reproducing block 12 receives the ACK signal (camera_ACK) via the communication control line 163-4 and the port 142 and notifies the main CPU 41 thereof, upon which the procedure goes to step S54. In step S54, the communication control block 131 transmits an ACK signal (drive_ACK) to the camera block 11 via the port 142 and the communication control line 163-3 on the basis of the completion of command packet transmission preparation by the main CPU 41, upon which the procedure goes to step S55, in which the communication control block 131 waits until a clock signal is received from the camera block 11.

Receiving the ACK signal (drive_ACK) via the communication control line 163-3, the camera block 11 transmits a predetermined clock signal via the serial I/F 111 and the serial clock line 161-2 (step S74 in FIGS. 10 and 12).

In step S55, the communication control block 131 of the recording/reproducing block 12 determines that the clock has been received via the serial line 161-2 and the serial I/F 141, upon which the procedure goes to step S56, in which the communication control block 131 controls the send queue controller 136 to transmit a command packet to the camera block 11 in synchronization with the received clock.

To be more specific, the main CPU 41 generates a command packet in step S21 of FIG. 6 and supplies the generated command packet to the send queue controller 136. The send queue controller 136 stores the supplied command packet in the send queue 138 and reads the command packet from the send queue 138 in step S56 under the control of the communication control block 131, supplying the command packet to the P/S conversion block 139. The P/S conversion block 139 P/S-converts the command packet in synchronization with the clock from the camera block 11 and supplies the converted command packet to the serial I/F 141. The serial I/F 141 transmits the received command packet to the camera block 11 via serial data line 161-1.

Receiving the command packet via the serial data line 161-1, the camera block 11 returns an ACK signal (camera_ACK) via the port 112 and the communication control line 163-4 (step S77 or S79 of FIGS. 11 and 12).

In step S57, receiving the ACK signal (camera_ACK) from the camera block 11 via the communication control line 163-4 and the port 142, the communication control block 131 of the recording/reproducing block 12 notifies the main CPU 41 thereof and, under the control of the main CPU 41, determines whether there is any data packet to be transmitted, or any command data packet in the send queue 138. If a data packet to be transmitted is found, the procedure goes to step S59, in which the communication control block 131 transmits an ACK signal (drive_ACK) to the camera block 11 via the port 142 and the communication control line 163-3 on the basis of the completion of command data packet send preparation by the main CPU 41, upon which the procedure goes to step S60, in which the communication control block 131 waits until a clock from the camera block 11 is received.

Receiving the ACK signal (drive_ACK) via the communication control line 163-3, the camera block 11 returns a predetermined clock via the serial I/F 111 and the serial clock line 161-2 (step S81 or S85 of FIGS. 11 and 12).

In step S60, the communication control block 131 of the recording/reproducing block 12 determines that the clock has been received via the serial clock line 161-2 and the serial I/F 141, upon which the procedure goes to step S61, in which the communication control block 131 controls the send queue controller 136 to transmit a command data packet to the camera block 11 in synchronization with the received clock, upon which the procedure returns to step S58 to repeat the above-mentioned processing therefrom.

Namely, the processing operations of steps S59 through S61 are repeated until all command data packets are transmitted in the recording/reproducing block 12 and the corresponding processing of the camera block 11 is also repeated (steps S84 through S86 of FIGS. 11 and 12).

If no more data packet to be transmitted is found in step S58, then the communication control block 131 ends this command packet send control processing. Subsequently, the procedure goes to step S25 of FIG. 6, in which command ACK packet send preparation processing is executed.

The following describes the command packet receive control processing of the camera block 11 with reference to the flowcharts shown in FIGS. 10 and 11.

The recording/reproducing block 12 transmits a REQ signal (drive_REQ) to the camera block 11 via the communication control line 163-1 of the port 142 (step S52 of FIGS. 8 and 12).

In step S71, the communication control block 101 of the camera block 11 waits until the REQ signal (drive_REQ) is received from the recording/reproducing block 12. The communication control block 101 receives the REQ signal (drive_REQ) via the communication control line 163-1 and the port 112 and notifies the camera CPU 21 thereof, upon which the procedure goes to step S72. In step S72, the communication control block 101 transmits an ACK signal (camera_ACK) to the recording/reproducing block 12 via the port 112 and the communication control line 163-4 on the basis of the acceptance of a command packet send request by the camera CPU 21.

Receiving the ACK signal (camera_ACK) via the communication control line 163-4, the recording/reproducing block 12 returns an ACK signal (drive_ACK) to the camera block 11 via the port 142 and the communication control line 163-3 (step S54 of FIGS. 8 and 12).

In step S73, the communication control block 101 of the camera block 11 receives the ACK signal (drive_ACK) via the communication control line 163-3 and the port 112 and notifies the camera CPU 21 thereof, upon which the procedure goes to step S74. In step S74, the communication control block 101 transmits a predetermined clock generated by an incorporated clock generator (not shown) to the recording/reproducing block 12 via the serial I/F 111 and the serial clock line 161-2 under the control of the camera CPU 21.

Receiving the clock via the serial clock line 161-2, the recording/reproducing block 12 transmits a command packet to the camera block 11 via the serial data line 161-1 (step S56 of FIGS. 8 and 12).

In step S75, the camera CPU 21 of the camera block 11 receives the command packet via the serial data line 161-1, the serial I/F 111, the S/P conversion block 103, and the receive queue controller 104 and executes parity check and analysis on the received command packet, upon which the procedure goes to step S76 of FIG. 11 if no error is found in the command packet.

To be more specific, the serial I/F 111 receives the command packet via the serial data line 161-1 and supplies the received command packet to the S/P conversion block 103. The S/P conversion block 103 executes S/P conversion on the received command packet on the basis of the clock from the communication control block 101 and supplies the converted command packet to the receive queue controller 104. The receive queue controller 104 stores the supplied command packet in the receive queue 105 and reads the command packet therefrom under the control of the camera CPU 21, supplying the command packet to the camera CPU 21.

It should be noted that, although not shown, if an error is detected in step S75, the camera CPU 21 controls the communication control block 101 to transmit a NACK signal (camera_NACK) to the recording/reproducing block 12 via the port 112 and the communication control line 163-6. Consequently, the command packet is retransmitted in the recording/reproducing block 12.

In step S76, the camera CPU 21 determines whether a command data packet is received after the command packet, namely, determines whether there is any data packet to be received. If no data packet to be received is found, then the procedure goes to step S77, in which the camera CPU 21 controls the communication control block 101 to transmit an ACK signal (camera_ACK) to the recording/reproducing block 12 via the port 112 and the communication control line 163-4, thereby ending this command packet receive control processing. Subsequently, the procedure goes to step S25 of FIG. 6, in which command ACK packet send preparation processing is executed.

If the camera CPU 21 determines in step S76 that there is a data packet to be received, the procedure goes to step S78, in which the camera CPU 21 gets the free space information of the receive queue 105 from the receive queue controller 104 and waits until the receive queue 105 becomes ready for reception. If the receive queue 105 is found ready for reception, then the procedure goes to step S79, in which the camera CPU 21 controls the communication control block 101 to transmit an ACK signal (camera_ACK) to the recording/reproducing block 12 via the port 112 and the communication control line 163-4, upon which the procedure goes to step S80.

Receiving the ACK signal (camera_ACK) via the communication control line 163-4, the recording/reproducing block 12 returns an ACK signal (drive_ACK) to the camera block 11 via the port 142 and the communication control line 163-3 (step S59 of FIGS. 9 and 12).

In step S80, the communication control block 101 of the camera block 11 receives the ACK signal (drive_ACK) via the communication control line 163-3 and the port 112 and notifies the camera CPU 21 thereof, upon which the procedure goes to step S81. In step S81, the communication control block 101 transmits a predetermined clock generated by an incorporated clock generator (not shown) to the recording/reproducing block 12 via the serial I/F 111 and the serial clock line 161-2 under the control of the camera CPU 21.

Receiving the clock via the serial clock line 161-2, the recording/reproducing block 12 returns a command data packet to the camera block 11 via the serial data line 161-1 (step S61 of FIGS. 9 and 12).

In step S82, the camera CPU 21 of the camera block 11 receives the command packet via the serial data line 161-1, the serial I/F 111, the S/P conversion block 103, and the receive queue controller 104 and executes parity check and analysis on the received command packet. If no error is found in the command packet, the procedure goes to step S83.

In step S83, the camera CPU 21 determines whether there is any more data packets to be received. If no data packet to be received is found, then the camera CPU 21 ends this command ACK packet send preparation processing.

If the camera CPU 21 determines that there is a data packet to be received in step S83, the procedure goes to step S84.

If there is a data packet to be transmitted, the recording/reproducing block 12 returns an ACK signal (drive_ACK) to the camera block 11 via the port 142 and the communication control line 163-3 (step S59 of FIGS. 9 and 12).

In step S84, the communication control block 101 of the camera block 11 receives the ACK signal (drive_ACK) via the communication control line 163-3 and the port 112 and notifies the camera CPU 21 thereof, upon which the procedure goes to step S85. In step S85, the communication control block 101 transmits a predetermined clock generated by an incorporated clock generator (not shown) to the recording/reproducing block 12 via the serial I/F 111 and the serial clock line 161-2 under the control of the camera CPU 21.

Receiving the clock via the serial clock line 161-2, the recording/reproducing block 12 returns a command data packet to the camera block 11 via the serial data line 161-1 (step S61 of FIGS. 9 and 12).

In step S86, the camera CPU 21 of the camera block 11 receives the command packet via the serial data line 161-1, the serial I/F 111, the S/P conversion block 103, and the receive queue controller 104 and executes parity check and analysis on the received command packet. If no error is found in the command packet, the procedure returns to step S83 to repeat the above-mentioned processing therefrom.

Namely, the processing operations of steps S84 through S86 are repeated until all command data packets have been received in the camera block 11 and the corresponding processing by the recording/reproducing block 12 is also repeated (steps S59 through S61 of FIGS. 9 and 12).

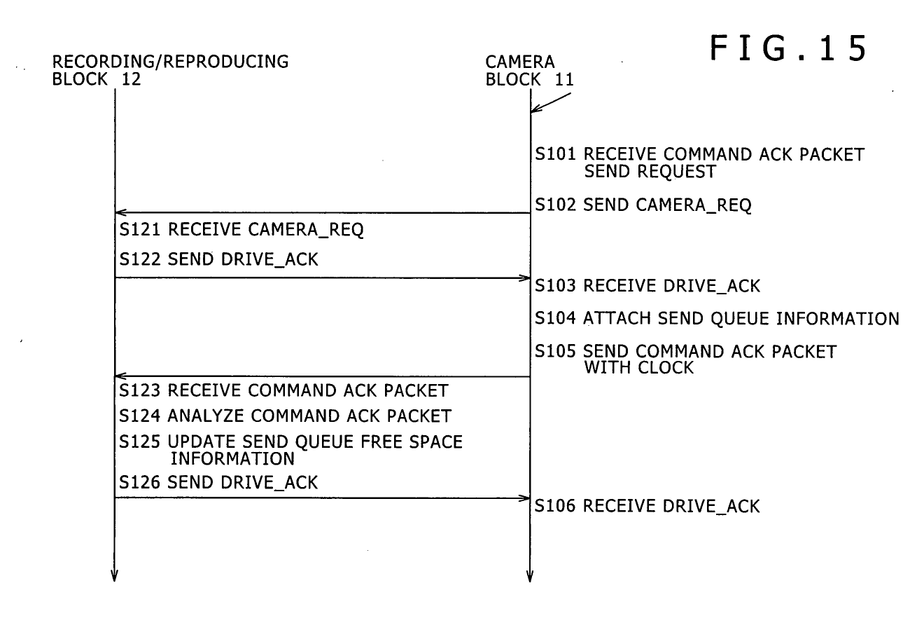

The following describes the command ACK packet send/receive control processing of step S27 shown in FIG. 6 with reference to the flowcharts of FIGS. 13 and 14 and the arrow chart of FIG. 15. FIG. 13 shows the command ACK packet send control processing of the camera block 11. FIG. 14 shows the command ACK packet receive control processing of the recording/reproducing block 12. FIG. 15 shows a relationship in processing between the camera block 11 and the recording/reproducing block 12.

In what follows, the processing operations by the camera block 11 and the recording/reproducing block 12 are individually described with reference to FIGS. 13 and 14. The relationship in processing between these blocks may easily be understood with reference of the corresponding steps shown in FIG. 15. It should be noted that, in FIG. 15, those steps which are not directly associated with the processing to be mutually executed by the camera block 11 and the recording/reproducing block 12 are appropriately skipped.

First, the command ACK packet send control processing by the camera block 11 will be described with reference to the flowchart shown in FIG. 13.

In step S101, the communication control block 101 of the camera block 11 waits until requested by the camera CPU 21 for the transmission of a command ACK packet. When a command ACK packet transmission request comes from the camera CPU 21, the procedure goes to step S102, in which the communication control block 101 transmits a REQ signal (camera_REQ) to the recording/reproducing block 12 via the port 112 and the communication control line 163-2.

Receiving the REQ signal (camera_REQ) via the communication control line 163-2, the recording/reproducing block 12 returns an ACK signal (drive_ACK) to the camera block 11 via the port 142 and the communication control line 163-3 (step S122 of FIGS. 14 and 15).

In step S103, the communication control block 101 of the camera block 11 receives the ACK signal (drive_ACK) via the communication control line 163-3 and the port 112 and notifies the camera CPU 21 thereof, checking the acceptance by the main CPU 41 of the recording/reproducing block 12, upon which the procedure goes to step S104.

In step S104, on the basis of the completion of the command ACK packet send preparation by the camera CPU 21, the communication control block 101 controls the send queue controller 106 to attach send queue information about the total capacity and free space of the send queue 108 to a command ACK packet, upon which the procedure goes to step S105. In step S105, the communication control block 101 transmits a predetermined clock to the recording/reproducing block 12 via the serial clock line 161-2 and controls the send queue controller 106 to transmit the command ACK packet attached with the send queue information.

To be more specific, the camera CPU 21 generates a command ACK packet in step S26 of FIG. 6 and supplies the generated command ACK packet to the send queue controller 106. The send queue controller 106 stores the supplied command ACK packet in the buffer 107. In step S104, the send queue controller 106 reads the command ACK packet from the buffer 107 and causes the information attachment block 113 to attach send queue information of the total capacity and free space of the send queue 108 to the command ACK packet under the control of the communication control block 101. In step S105, the send queue controller 106 supplies the command ACK packet attached with the send queue information to the P/S conversion block 109.

At this moment, the communication control block 101 transmits a predetermined clock to the recording/reproducing block 12 and the P/S conversion block 109 via the serial clock line 161-2. In synchronization with the clock supplied from the communication control block 101, the P/S conversion block 109 P/S-converts the command ACK packet and supplies the converted command ACK packet to the serial I/F 111. The serial I/F 111 transmits the command ACK packet from the P/S conversion block 109 to the recording/reproducing block 12 via the serial data line 161-1.

The recording/reproducing block 12 receives the clock via the serial clock line 161-2 and, in synchronization with the received clock, receives the command ACK packet via the serial data line 161-1. Then the recording/reproducing block 12 returns an ACK signal (drive_ACK) to the camera block 11 via the port 142 and the communication control line 163-3 (step S126 of FIGS. 14 and 15).

In step S106, the communication control block 101 of the camera block 11 receives the ACK signal (drive_ACK) via the communication control line 163-3 and the port 112 and notifies the camera CPU 21 thereof. Consequently, camera CPU 21 confirms that the command ACK packet has been received by the recording/reproducing block 12 and ends this command ACK packet send control processing. Then, the procedure goes to step S28 of FIG. 6, in which the transmission of the command packet generated in step S21 is determined.

The following describes the command ACK packet receive control processing of the recording/reproducing block 12 with reference to the flowchart shown in FIG. 14.

The camera block 11 transmits a REQ signal (camera_REQ) to the recording/reproducing block 12 via the port 112 and the communication control line 163-2 (step S102 of FIGS. 13 and 15).

In step S121, the communication control block 131 of the recording/reproducing block 12 waits until the REQ signal (camera_REQ) comes from the camera block 11. The communication control block 131 receives the REQ signal (camera_REQ) via the port 142 and the communication control line 163-2 and notifies the main CPU 41 thereof, upon which the procedure goes to step S122. In step S122, the communication control block 131 transmits an ACK signal (drive_ACK) to the camera block 11 via the port 142 and the communication control line 163-3 on the basis of the acceptance of a command ACK packet send request by the main CPU 41.

It should be noted that, in the example shown in FIG. 13, no REQ signal (drive_REQ) has been transmitted from the recording/reproducing block 12 (namely, no REQ signal has not been received approximately at the same time in the camera block 11 and the recording/reproducing block 12), so that the communication control block 131 transmits an ACK signal (drive_ACK) to the camera block 11 when the main CPU 41 becomes ready for receiving a command ACK packet.

Receiving the ACK signal (drive_ACK) through the communication control line 163-3, the camera block 11 transmits a predetermined clock via the serial clock line 161-2 and a command ACK packet via the serial data line 161-1 (step S105 of FIGS. 13 and 15).

In step S123, the main CPU 41 of the recording/reproducing block 12 receives the command ACK packet via the serial data line 161-1 in synchronization with the clock received via the serial clock line 161-2, upon which the procedure goes to step S124.

To be more specific, the clock received via the serial clock line 161-2 and the serial I/F 141 is supplied to the communication control block 131 and the S/P conversion block 133. The serial I/F 141 supplies the command ACK packet received via the serial data line 161-1 to the S/P conversion block 133. The S/P conversion block 133 S/P-converts a command ACK packet in synchronization with the clock from the serial I/F 141 and supplies the converted command ACK packet to the receive queue controller 134.

The receive queue controller 134 stores the supplied command ACK packet in the receive queue 135 and reads the command ACK packet from the receive queue 135, supplying the command ACK packet to the main CPU 41 under the control of the main CPU 41.

In step S124, the main CPU 41 of the recording/reproducing block 12 executes parity check and analysis on the command ACK packet. If no error is detected in the command ACK packet, then the main CPU 41 gets the send queue information attached to the command ACK packet, upon which the procedure goes to step S125.

It should be noted that, although not shown, if an error is detected in step S124, the main CPU 41 controls the communication control block 131 to transmit a NACK signal (drive NACK) to the camera block 11 via the port 142 and the communication control line 163-5. Consequently, the command ACK packet is retransmitted in the camera block 11.

In step S125, the main CPU 41 of the recording/reproducing block 12 updates the stored free space information of the send queue 108 of the camera block 11 on the basis of the obtained send queue information, upon which the procedure goes to step S126. The updated free space information of the send queue 108 is compared with a predetermined threshold in above-mentioned step S23 of FIG. 6, thereby executing command communication control.

In step S126, the main CPU 41 of the recording/reproducing block 12 controls the communication control block 131 to transmit an ACK signal (drive_ACK) to the camera block 11 via the port 142 and communication control line 163-3, thereby ending this command ACK packet receive control processing. Then, the procedure goes to step S28, in which the transmission of the command packet generated in step S21 is determined.

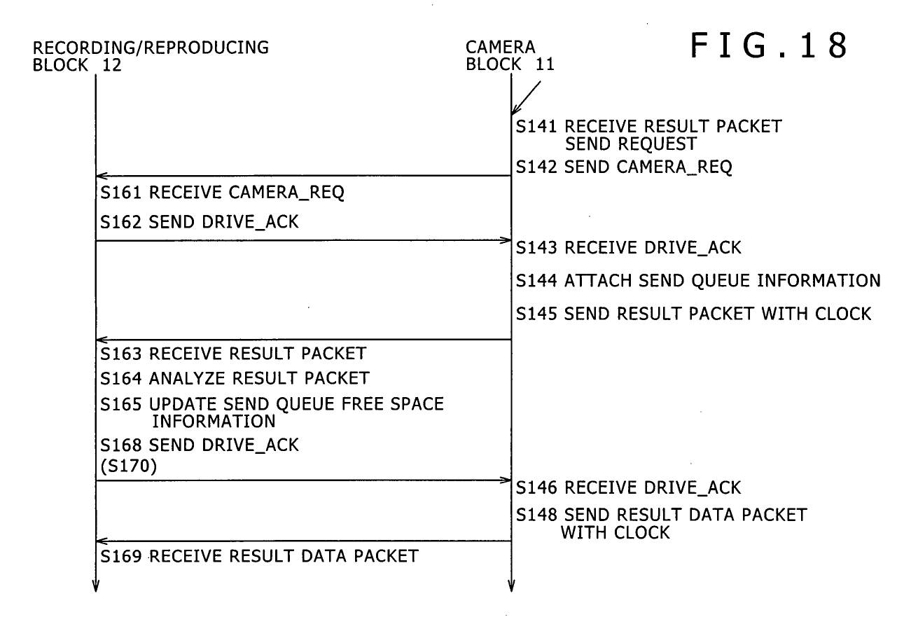

The following describes result packet send/receive control processing of step S31 shown in FIG. 6 with reference to the flowcharts shown in FIGS. 16 and 17 and the arrow chart shown in FIG. 18. FIG. 16 shows result packet send control processing of the camera block 11. FIG. 17 shows result packet receive control processing of the recording/reproducing block 12. FIG. 18 shows a relationship in processing between the camera block 11 and the recording/reproducing block 12.

In what follows, the processing operations by the camera block 11 and the recording/reproducing block 12 are individually described with reference to FIGS. 16 and 17. The relationship in processing between these blocks may easily be understood with reference of the corresponding steps shown in FIG. 18. It should be noted that, in FIG. 18, those steps which are not directly associated with the processing to be mutually executed by the camera block 11 and the recording/reproducing block 12 are appropriately skipped.

First, the result packet send control processing by the camera block 11 will be described with reference to the flowchart shown in FIG. 16.

In step S141, the communication control block 101 of the camera block 11 waits until a result packet send request is made from the camera CPU 21. When a result packet send request comes from the camera CPU 21, the procedure goes to step S142, in which the communication control block 101 transmits a REQ signal (camera_REQ) to the recording/reproducing block 12 via the communication control line 163-2 of the port 112.

Receiving the REQ signal (camera_REQ) via the communication control line 163-2, the recording/reproducing block 12 returns an ACK signal (drive_ACK) to the camera block 11 via the communication control line 163-3 (step S162 of FIGS. 17 and 18).

In step S143, the communication control block 101 of the camera block 11 receives the ACK signal (drive_ACK) via the communication control line 163-3 and the port 112 and notifies the camera CPU 21 thereof and confirms the acceptance of the reception by the main CPU 41 of the recording/reproducing block 12, upon which the procedure goes to step S144. In step S144, on the basis of the completion of the result packet send preparation by the camera CPU 21, the communication control block 101 controls the send queue controller 106 to attach the send queue information about the total capacity and free space of the send queue 108 to a result packet, upon which the procedure goes to step S145. In step S145, the communication control block 101 transmits a predetermined clock to the recording/reproducing block 12 via the serial clock line 161-2 and controls the send queue controller 106 to transmit the result packet attached with the send queue information.

To be more specific, the camera CPU 21 generates a result packet in step S30 of FIG. 6 and supplies the generated result packet to the send queue controller 106. The send queue controller 106 stores the received result packet in the send queue 108, reads the result packet therefrom in step S104, and causes the information attachment block 113 to attach send queue information about the total capacity and free space of the send queue 108 to the result packet, thereby supplying the result packet attached with the send queue information to the P/S conversion block 109 in step S105.

At this moment, the communication control block 101 transmits a predetermined clock to the recording/reproducing block 12 via the serial clock line 161-2 and to the P/S conversion block 109. In synchronization with the clock supplied from the communication control block 101, the P/S conversion block 109 P/S-converts the result packet and supplies the converted result packet to the serial I/F 111. The serial I/F 111 transmits the result packet from the P/S conversion block 109 to the recording/reproducing block 12 via the serial data line 161-1.

Receiving the clock via the serial clock line 161-2 and receiving the result packet in synchronization with the received clock via the serial data line 161-1, the recording/reproducing block 12 transmits an ACK signal (drive_ACK) via the port 142 and the communication control line 163-3 to the camera block 11 (step S168 or S170 of FIGS. 17 and 18).

In step S146, the communication control block 101 of the camera block 11 receives the ACK signal (drive_ACK) via the communication control line 163-3 and the port 112 and notifies the camera CPU 21 thereof. The camera CPU 21 confirms whether the result packet has been received by the recording/reproducing block 12. In step S147, the camera CPU 21 determines whether there is any data packet to be transmitted, namely, whether there is a result data packet in the send queue 108. If no data packet to be transmitted is found, the camera CPU 21 ends this command packet send control processing. Subsequently, the procedure goes to step S32 in FIG. 6, in which the transmission of the command packet generated in step S21 is determined.

If a data packet to be transmitted is found in step S147, then the procedure goes to step S148, in which the communication control block 101 transmits a predetermined clock to the recording/reproducing block 12 via the serial clock line 161-2 on the basis of the completion of result packet send preparation by the camera CPU 21 and controls the send queue controller 106 to transmit the result data packet attached with the send queue information.

The recording/reproducing block 12 receives the clock via the serial clock line 161-2 and, in synchronization with the received clock, receives the result data packet via the serial data line 161-1. When the recording/reproducing block 12 becomes ready for reception, the recording/reproducing block 12 transmits an ACK signal (drive_ACK) to the camera block 11 via the port 142 and the communication control line 163-3 (step S168 of FIGS. 17 and 18).

In step S149, the communication control block 101 receives the ACK signal (drive_ACK) via the communication control line 163-3 and the port 112 and notifies the camera CPU 21 thereof. Consequently, the camera CPU 21 confirms that the result packet has been received by the recording/reproducing block 12, upon which the procedure returns to step S147 to repeat the above-mentioned processing therefrom.

Namely, the processing operations of steps S148 and S149 are repeated until all result packages have been transmitted in the camera block 11 and the corresponding processing of the recording/reproducing block 12 is also repeated (steps S167 through S169 of FIGS. 17 and 18).

The following describes the result packet receive control processing of the recording/reproducing block 12 with reference to the flowchart shown in FIG. 17.

The camera block 11 transmits a REQ signal (camera_REQ) to the recording/reproducing block 12 via the communication control line 163-2 of the port 112 (step S142 of FIGS. 16 and 18).

In step S161, the communication control block 131 of the recording/reproducing block 12 waits until the REQ signal (camera_REQ) is received from the camera block 11. When the REQ signal is received via the port 142 and the communication control line 163-2, the communication control block 131 notifies the main CPU 41 thereof, upon which the procedure goes to step S162. In step S162, the communication control block 131 returns an ACK signal (drive_ACK) to the camera block 11 via the port 142 and the communication control line 163-3 on the basis of the acceptance of a result packet send request by the main CPU 41.

It should be noted that, as with the example shown in FIG. 14, in the example shown in FIG. 17, no REQ signal (drive_REQ) has been transmitted from the recording/reproducing block 12 (namely, no REQ signal has not been received approximately at the same time in the camera block 11 and the recording/reproducing block 12), so that the communication control block 131 transmits an ACK signal (drive_ACK) to the camera block 11 when the main CPU 41 becomes ready for receiving a command ACK packet.

Receiving the ACK signal (drive_ACK) via the communication control line 163-3, the camera block 11 transmits a predetermined clock via the serial clock line 161-2 and transmits a result packet via the serial data line 161-1 (step S145 of FIG. 16).

In step S163, the main CPU 41 of the recording/reproducing block 12 receives the result packet via the serial data line 161-1 in synchronization with the clock received via the serial clock line 161-2, upon which the procedure goes to step S164.

To be more specific, the clock received via the serial clock line 161-2 and the serial I/F 141 is supplied to the communication control block 131 and the S/P conversion block 133. The serial I/F 141 also supplies the result packet received via the serial data line 161-1 to the S/P conversion block 133. The S/P conversion block 133 S/P-converts the result packet in synchronization with the clock received from the serial I/F 141 and supplies the converted result packet to the receive queue controller 134.

The receive queue controller 134 stores the supplied result packet in the receive queue 135 and reads the result packet therefrom under the control of the main CPU 41, supplying the result packet to the main CPU 41.

In step S164, the main CPU 41 of the recording/reproducing block 12 executes parity check and analysis on the received result packet. If no error is detected in the result packet, the main CPU 41 gets the send queue information attached to the result packet, upon which the procedure goes to step S165.

It should be noted that, although not shown, if an error is detected in step S164, the main CPU 41 controls the communication control block 131 to transmit a NACK signal (drive NACK) to the camera block 11 via the port 142 and the communication control line 163-5. Consequently, the command ACK packet is retransmitted in the camera block 11.

In step S165, the main CPU 41 of the recording/reproducing block 12 updates the stored free space information of the send queue 108 of the camera block 11 on the basis of the obtained send queue information, upon which the procedure goes to step S166. The updated free space information of the send queue 108 is compared with a predetermined threshold in above-mentioned step S23 of FIG. 6, thereby executing command packet send control.

In step S166, the main CPU 41 of the recording/reproducing block 12 determines whether a result data packet is received after the result packet, namely whether there is any data to be received. If data to be received is found, then the procedure goes to step S167, in which the main CPU 41 gets the free space information of the receive queue 135 and waits until the receive queue 135 becomes ready for reception. When the receive queue 135 is found ready for reception, then the main CPU 41 controls the communication control block 131 in step S168 to transmit an ACK signal (camera_ACK) to the recording/reproducing block 12 via the port 112 and the communication control line 163-4, upon which the procedure goes to step S169.

Receiving the ACK signal (drive_ACK) via the communication control line 163-3, the camera block 11 transmits a predetermined clock via the serial clock line 161-2 and a result data packet via the serial data line 161-1 (step S149 of FIG. 16).

In step S169, the main CPU 41 of the recording/reproducing block 12 receives the result data packet via the serial data line 161-1 in synchronization with the clock received via the serial clock line 161-2, upon which the procedure returns to step S166 to repeat the above-mentioned processing therefrom.

Namely, in the recording/reproducing block 12, the processing operations of steps S167 through S169 are repeated until all result data packets are received and the corresponding processing of the camera block 11 is also repeated (steps S148 and S149 of FIGS. 16 and 18).

If no data to be received is found in step S166, the procedure goes to step S170, in which the main CPU 41 controls the communication control block 131 to transmit an ACK signal (camera_ACK) to the recording/reproducing block 12 via the port 112 and the communication control line 163-4, thereby ending this result packet receive control processing. Subsequently, the procedure goes to step S32, in which the transmission of the command packet generated in step S21 is determined.

Thus, send queue information is attached to each result packet that is a result of the execution of a command packet and each command ACK packet that corresponds to a command packet one to one, so that the send queue information on the side of the camera block 11 may be obtained. This configuration prevents the camera block 11 from getting uncontrollable due to an overflow in the send queue of the camera block 11 for example only by controlling the recording/reproducing block 12, thereby providing comfortable packet communication between the camera block and the recording/reproducing block via serial lines.

In the recording/reproducing block 12, once a command packet has been transmitted to the camera block 11, a next command packet cannot be transmitted until a command ACK packet corresponding to the transmitted command packet is received. Namely, in the recording/reproducing block 12, every time a command packet is transmitted, a corresponding command ACK packet is always received.

Consequently, attaching send queue information to each command ACK packet always allows the acquisition of the send queue information every time a command packet is transmitted. This is more advantageous than attaching send queue information only to a result packet, because the buffer information on the camera block side may be obtained from time to time.

In addition, if a command ACK packet (or a result packet) attached with send queue information is received by the recording/reproducing block and the send queue free space indicated by the send queue information is smaller than a predetermined threshold, then the recording/reproducing block does not transmit commands, thereby freeing the communication route for the transmission by the camera block. Namely, a command ACK packet (or a result packet) attached with send queue information is said to be a packet indicative of a request for clearing the transmission route.

It should be noted that, in the above description, an example is used in which only one of a REQ signal (drive_REQ) from the recording/reproducing block 12 or a REQ signal (camera_REQ) from the camera block 11 has been transmitted in each packet send/receive operation, namely, a REQ signal (drive_REQ) from the recording/reproducing block 12 and a REQ signal (camera_REQ) from the camera block 11 have not caused interrupts approximately at the same time. However, there may be a situation in which a REQ signal (drive_REQ) from the recording/reproducing block 12 and a REQ signal (camera_REQ) from the camera block 11 have caused interrupts approximately at the same time.

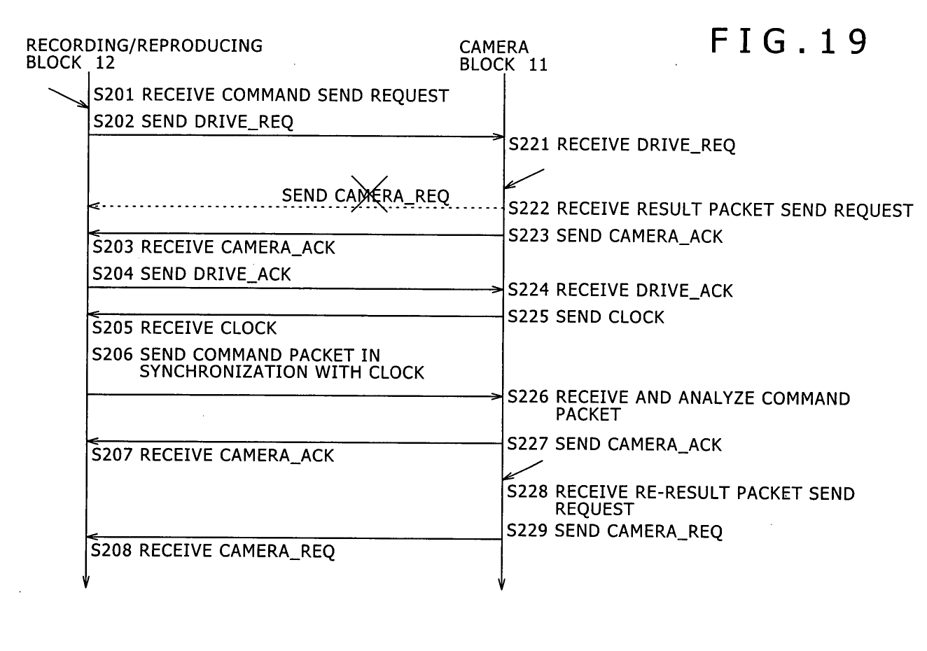

The following describes packet send/receive control processing to be executed when a REQ signal (drive_REQ) from the recording/reproducing block 12 and a REQ signal (camera_REQ) from the camera block 11 have caused interrupts approximately at the same time with reference to the arrow charts shown in FIGS. 19 through 22.

It should be noted that the packet send/receive control processing shown in FIGS. 19 through 22 is another example of the packet send/receive control processing described above with reference to FIGS. 8 through 18. The individual processing of the recording/reproducing block 12 and the camera block 11 is basically the same as that in which a REQ signal (drive_REQ) from the recording/reproducing block 12 and a REQ signal (camera_REQ) from the camera block 11 have not been transmitted. Therefore, the illustration and detail description of the packet send/receive control processing shown in FIGS. 19 through 22 will be skipped.

First, an example will be described with reference to the arrow chart of FIG. 19 in which the transmission of a REQ signal (drive_REQ) from the recording/reproducing block 12 is sufficiently faster than the transmission of a REQ signal (camera_REQ) from the camera block 11.

In step S201, when the communication control block 131 of the recording/reproducing block 12 is requested by the main CPU 41 for the transmission of a command packet, the procedure goes to step S202, in which the communication control block 131 transmits a REQ signal (drive_REQ) to the camera block 11 via the communication control line 163-1 of the port 142.

In response, in step S221, the communication control block 101 of the camera block 11 receives the REQ signal (drive_REQ) via the port 112 and the communication control line 163-1.

On the other hand, the camera CPU 21 of the camera block 11 has completed the processing of a previous command and, as a result thereof, requests the communication control block 101 for the transmission of a result packet. In step S222, the communication control block 101 is requested by the camera CPU 21 for the transmission of a result packet. Because the REQ signal (drive_REQ) has been received in step S221, communication control block 101 transmits a notice thereof to the camera CPU 21 to put a result packet transmission request into a wait state, thereby disabling the transmission of a REQ signal (camera_REQ).

Next, in step S223, the communication control block 101 of the camera block 11 transmits an ACK signal (camera_ACK) via the port 112 and the communication control line 163-4 on the basis of the acceptance of command packet reception by the camera CPU 21.

In step S203, the communication control block 131 of the recording/reproducing block 12 receives the ACK signal (camera_ACK) via the communication control line 163-4 and the port 142. When the command packet send preparation by the main CPU 41 has been completed, the procedure goes to step S204, in which the communication control block 131 transmits an ACK signal (drive_ACK) to the camera block 11 via the port 142 and the communication control line 163-3.

In step S224, the communication control block 101 of the camera block 11 receives the ACK signal (drive_ACK) via the communication control line 163-3, upon which the procedure goes to step S225, in which the communication control block 101 transmits a predetermined clock via the serial I/F 111 and serial clock line 161-2.

In step S205, the communication control block 131 of the recording/reproducing block 12 receives the clock via the serial clock line 161-2 and the serial I/F 141 and notifies the main CPU 41 thereof. In step S206, the main CPU 41 controls the send queue controller 136 to transmit a command packet to the camera block 11 in synchronization with the clock received in step S205.

In step S226, the camera CPU 21 of the camera block 11 receives the command packet via the serial data line 161-1 and analyzes the received command packet. If no error is detected in the command packet, then the procedure goes to step S227, in which the camera CPU 21 controls the communication control block 101 to transmit an ACK signal (camera_ACK) to the recording/reproducing block 12 via the port 112 and the communication control line 163-4.

In step S207, the communication control block 131 of the recording/reproducing block 12 receives the ACK signal (camera_ACK) from the camera block 11 via the communication control line 163-4 and the port 142 and notifies the main CPU 41 thereof. Consequently, the main CPU 41 confirms that the command transmission has been completed.

On the other hand, the camera CPU 21 of the camera block 11 requests the communication control block 101 for the retransmission of a result packet kept in a standby state after the transmission of the ACK signal (camera_ACK) by the communication control block 101. In step S228, the communication control block 101 receives a result packet transmission request from the camera CPU 21. In step S229, the communication control block 101 transmits a REQ signal (camera_REQ) to the recording/reproducing block 12 via the communication control line 163-2 of the port 112.

Because the command transmission has been completed in step S207, the communication control block 131 of the recording/reproducing block 12 receives the REQ signal (camera_REQ) from the camera block 11 in step S208.

It should be noted that the processing operations subsequent to steps S208 and S229 of FIG. 19 are generally the same as the result packet send/receive control processing (or the processing operations subsequent to steps S162 and S143) of FIGS. 16 through 18, so that the description thereof will be omitted for brevity.

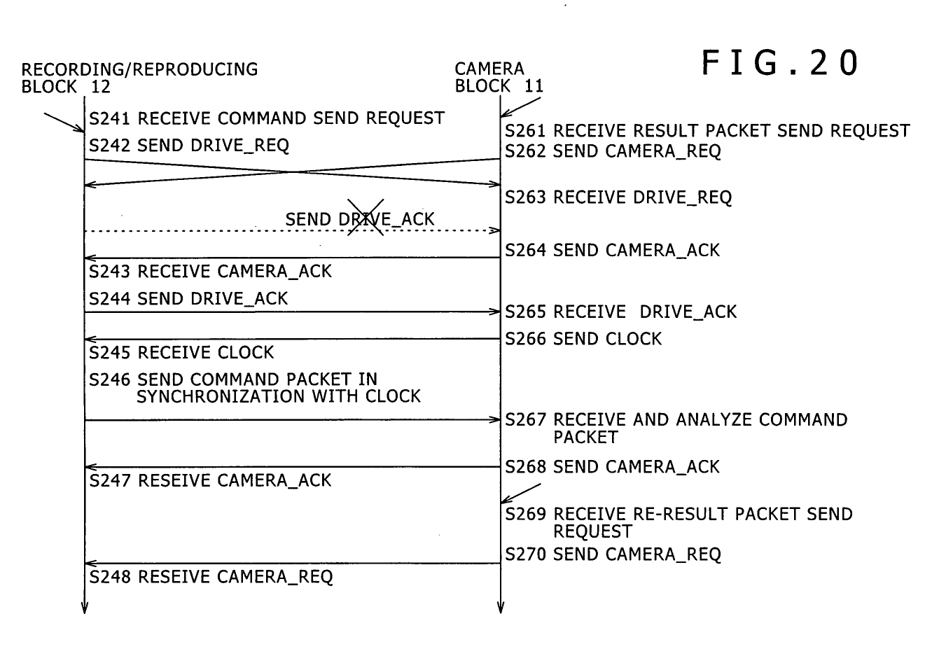

The following describes a case in which a REQ signal (camera_REQ) from the camera block 11 is received immediately after the transmission of a REQ signal (drive_REQ) from the recording/reproducing block 12, with reference to the arrow chart shown in FIG. 20.

When a command packet transmission request comes from the main CPU 41 in step S241, procedure goes to step S242, in which the communication control block 131 of the recording/reproducing block 12 transmits the REQ signal (drive_REQ) to the camera block 11 via the communication control line 163-1 of the port 142.

On the other hand, the camera CPU 21 of the camera block 11 completes the processing of previous command execution and requests the communication control block 101 for the transmission of a result packet as a result of the completion. In step S261, the communication control block 101 of the camera block 11 accepts the request for the transmission of a result packet from the camera CPU 21. In step S262, the communication control block 101 transmits a REQ signal (camera_REQ) to the recording/reproducing block 12 via the communication control line 163-2 of the port 112 and waits for an ACK (drive_ACK) from the recording/reproducing block 12 (namely, the acceptance of result packet receive request).

However, in step S263, the communication control block 101 of the camera block 11 receives the REQ signal (drive_REQ) that is a command packet send request via the port 112 and the communication control line 163-1. Reception of not an ACK signal (drive_ACK) but a REQ signal (drive_REQ) tells the communication control block 101 that no REQ signal (camera_REQ) has not been received in the recording/reproducing block 12. The communication control block 101 notifies the camera CPU 21 thereof. The camera CPU 21 receives the command packet send request and waits for a result packet send request. In step S264, the camera CPU 21 controls the communication control block 101 to transmit an ACK signal (camera_ACK) via the port 112 and the communication control line 163-4.

The REQ signal (camera_REQ) comes from the camera block 11 via communication control line 163-2. However, because the REQ signal (drive_REQ) has been received in step S242, the communication control block 131 of the recording/reproducing block 12 ignores the reception of the REQ signal (camera_REQ) and does not transmit (or prohibits the transmission of) an ACK signal (drive_ACK), upon which the procedure goes to step S243.

In step S243, the communication control block 131 of the recording/reproducing block 12 receives the ACK signal (camera_ACK) from the camera block 11 via the communication control line 163-4. When the command packet send preparation by the main CPU 41 has been completed, the procedure goes to step S244, in which the communication control block 131 transmits an ACK signal (drive_ACK) to the camera block 11 via the port 142 and the communication control line 163-3.

In step S265, the communication control block 101 of the camera block 11 receives the ACK signal (drive_ACK) via the communication control line 163-3, upon which the procedure goes to step S266, in which the communication control block 101 transmits a predetermined clock via the serial I/F 111 and the serial clock line 161-2.

In step S245, the communication control block 131 of the recording/reproducing block 12 receives the clock via the serial clock line 161-2 and the serial I/F 141 and notifies the main CPU 41 thereof. In step S246, the main CPU 41 controls the send queue controller 136 to transmit a command packet to the camera block 11 in synchronization with the clock received in step S245.

In step S267, the camera CPU 21 of the camera block 11 receives the command packet via the serial data line 161-1 and analyzes the received command packet. If no error is detected in the command packet, the procedure goes to step S268, in which the camera CPU 21 controls the communication control block 101 to transmit an ACK signal (camera_ACK) to the recording/reproducing block 12 via the port 112 and the communication control line 163-4.

In step S247, the communication control block 131 of the recording/reproducing block 12 receives the ACK signal (camera_ACK) from the camera block 11 via the communication control line 163-4 and the port 142 and notifies the main CPU 41 thereof. Consequently, the main CPU 41 confirms that the command transmission has been completed.

On the other hand, after the transmission of the ACK signal (camera_ACK) by the communication control block 101, the camera CPU 21 of the camera block 11 requests the communication control block 101 for the retransmission of a result packet kept in a standby state. In step S269, the communication control block 101 receives a result packet send request, upon which the procedure goes to step S270, in which the communication control block 101 transmits a REQ signal (camera_REQ) to the recording/reproducing block 12 via the communication control line 163-2 of the port 112.

Because the command transmission has been completed in step S247, the communication control block 131 of the recording/reproducing block 12 receives the REQ signal (camera_REQ) from the camera block 11 in step S248.

It should be noted that the processing operations subsequent to steps S248 and S270 shown in FIG. 20 are generally the same as the result packet send/receive control processing (or the processing operations subsequent to steps S162 and S143) of FIGS. 16 through 18, so that the description thereof will be omitted for brevity.

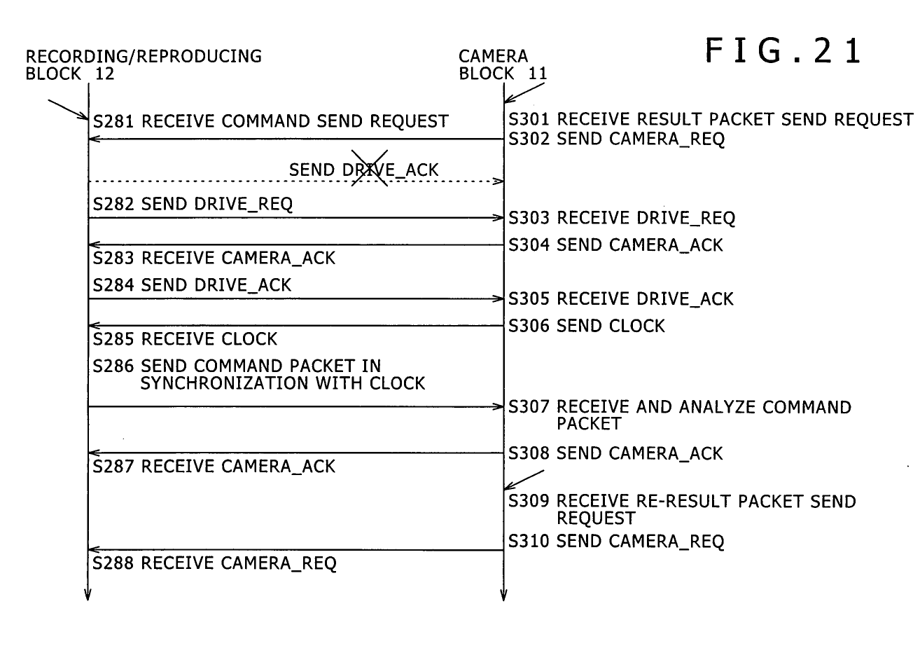

The following describes a case in which a REQ signal (camera_REQ) is received from the camera block 11 immediately before a REQ signal (drive_REQ) is transmitted from the recording/reproducing block 12, with reference to the arrow chart shown in FIG. 21.

When the execution of a previous command has been completed, the camera CPU 21 of the camera block 11 requests the communication control block 101 for the transmission of a result packet as a result of the completion. In step S301, the transmission of a result packet is requested by the camera CPU 21. In sep S302, the communication control block 101 transmits a REQ signal (camera_REQ) to the recording/reproducing block 12 via the communication control line 163-2 of the port 112 and waits for an ACK signal (drive_ACK) from the recording/reproducing block 12 (namely, the acceptance of the result packet receive request).

On the other hand, when the communication control block 131 of the recording/reproducing block 12 receives the command packet send request from the main CPU 41 in step S281, the REQ signal (camera_REQ) comes from the camera block 11 via the communication control line 163-2 immediately thereafter.

However, because the communication control block 131 of the recording/reproducing block 12 has received a command packet send request from the main CPU 41 in step S281 immediately before the transmission of the REQ signal (camera_REQ), the communication control block 131 ignores the reception of the REQ signal (camera_REQ) and does not transmit (or prohibits the transmission of) an ACK signal (drive_ACK), upon which the procedure goes to step S282. In step S282, in response to the command packet send request from the main CPU 41, the communication control block 131 transmits a REQ signal (drive_REQ) to the camera block 11 via the communication control line 163-1 of the port 142.

In step S303, the communication control block 101 of the camera block 11 receives the REQ signal (drive_REQ) that is a command packet send request via the port 112 and the communication control line 163-1. Because not the ACK signal (drive_ACK) but the REQ signal (drive_REQ) has been received from the recording/reproducing block 12, the communication control block 101 recognizes that no REQ signal (camera_REQ) has been received at the recording/reproducing block 12 and notifies the camera CPU 21 thereof. The camera CPU 21 accepts the command packet send request and waits for a result packet send request, upon which the procedure goes to step S304, in which the camera CPU 21 controls the communication control block 101 to transmit an ACK signal (camera_ACK) via the 112 and the communication control line 163-4.

In step S283, the communication control block 131 of the recording/reproducing block 12 receives the ACK signal (camera_ACK) from the camera block 11 via the communication control line 163-4. When the command packet sent preparation has been completed, the procedure goes to step S284, in which the communication control block 131 transmits an ACK signal (drive_ACK) to the camera block 11 via the port 142 and the communication control line 163-3.

In step S305, the communication control block 101 of the camera block 11 receives the ACK signal (drive_ACK) via the communication control line 163-3. In step S306, the communication control block 101 transmits a predetermined clock via the serial I/F 111 and the serial clock line 161-2.

In step S285, the communication control block 131 of the recording/reproducing block 12 receives the clock via the serial clock line 161-2 and the serial I/F 141 and notifies the main CPU 41 thereof. In step S286, the main CPU 41 controls the send queue controller 136 to transmit a command packet to the camera block 11 in synchronization with the received clock.

In step S307, the camera CPU 21 of the camera block 11 receives the command packet via the serial data line 161-1 and analyzes the received command packet. If no error is detected in the command packet, the procedure goes to step S308, in which the camera CPU 21 controls the communication control block 101 to transmit an ACK signal (camera_ACK) to the recording/reproducing block 12 via the port 112 and the communication control line 163-4.

In step S287, the communication control block 131 of the recording/reproducing block 12 receives the ACK signal (camera_ACK) from the camera block 11 via the communication control line 163-4 and the port 142 and notifies the main CPU 41 thereof. Consequently, the main CPU 41 confirms that the command send processing has been completed.

On the other hand, camera CPU 21 of the camera block 11 requests the communication control block 101 for the retransmission of a result packet kept in a standby state after the transmission of the ACK signal (camera_ACK) by the communication control block 101. In step S309, the communication control block 101 receives a result packet send request from the camera CPU 21. In step S310, the communication control block 101 transmits a REQ signal (camera_REQ) to the recording/reproducing block 12 via the communication control line 163-2 of the port 112.

Because the command transmission has been completed in step S287, the communication control block 131 of the recording/reproducing block 12 receives the REQ signal (camera_REQ) from the camera block 11 in step S288.

It should be noted that the processing operations subsequent to steps S288 and S310 shown in FIG. 21 are generally the same as the result packet send/receive control processing (or the processing operations subsequent to steps S162 and S143) of FIGS. 16 through 18, so that the description thereof will be omitted for brevity.

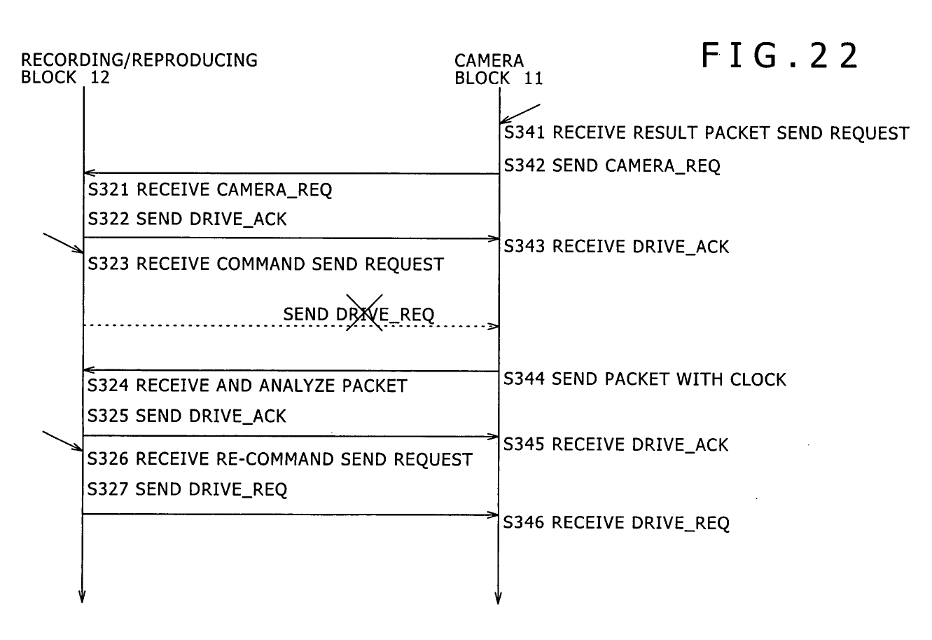

The following describes a case in which the transmission of a REQ signal (camera_REQ) from the camera block 11 is sufficiently faster than the transmission of a REQ signal (drive_REQ) from the recording/reproducing block 12, with reference to the arrow chart shown in FIG. 22.

Having completed the execution of a previous command, the camera CPU 21 of the camera block 11 requests the communication control block 101 for the transmission of a result packet as a result of the completion. In step S341, the communication control block 101 of the camera block 11 receives the result packet send request from the camera CPU 21. In step S342, the communication control block 101 transmits a REQ signal (camera_REQ) to the recording/reproducing block 12 via the communication control line 163-2 of the port 112 and waits for an ACK signal (drive_ACK) from the recording/reproducing block 12 (namely, the acceptance of the result packet receive request).

In step S321, the communication control block 131 of the recording/reproducing block 12 receives the REQ signal (camera_REQ) via the communication control line 163-2. When the result packet receive preparation by the main CPU 41 has been completed, the communication control block 131 transmits an ACK signal (drive_ACK) that is the acceptance of the result packet receive request to the camera block 11 via the port 142 and the communication control line 163-3 in step S322. Then, the procedure goes to step S323.

The main CPU 41 of the recording/reproducing block 12 requests the communication control block 131 for the transmission of a next command packet. In step S323, the communication control block 131 of the recording/reproducing block 12 receives the command packet send request from the main CPU 41; however, because the ACK signal (drive_ACK) has already been transmitted to the camera block 11 in step 322, the communication control block 131 notifies the main CPU 41 thereof to put a command packet send request in a standby state, thereby not executing (or disabling) the transmission of a REQ signal (drive_REQ).

In step S343, the communication control block 101 of the camera block 11 receives the ACK signal (drive_ACK) via the port 112 and the communication control line 163-3. When the result packet send preparation (including the attachment of send queue information) has been completed by the camera CPU 21, the procedure goes to step S344. In step S344, the communication control block 101 transmits a predetermined clock via the serial I/F 111 and the serial clock line 161-2 and controls the send queue controller 106 to transmit a result packet via the serial data line 161-1.

In step S324, the main CPU 41 of the recording/reproducing block 12 receives the result packet via the serial data line 161-1 and analyzes the received result packet. If no error is detected in the result packet, then the procedure goes to step S325, in which the main CPU 41 controls the communication control block 131 to transmit an ACK signal (drive_ACK) to the camera block 11 via the port 142 and the communication control line 163-3.

In step S345, the communication control block 101 of the camera block 11 receives the ACK signal (drive_ACK) from the recording/reproducing block 12 via the communication control line 163-3 and the port 112 and notifies the camera CPU 21 thereof. Consequently, the camera CPU 21 confirms that the transmission of the result packet has been completed.

On the other hand, after the transmission of the ACK signal (drive_ACK) by the communication control block 131, the main CPU 41 of the recording/reproducing block 12 requests the communication control block 131 for the retransmission of a next command packet kept in a standby state. In step S326, the communication control block 131 receives the request for the command packet transmission. In step S327, the communication control block 131 transmits a REQ signal (drive_REQ) to the camera block 11 via the communication control line 163-1 of the port 142.

In response, the in step S221, the communication control block 101 of the camera block 11 receives the REQ signal (drive_REQ) via the port 112 and the communication control line 163-1.

It should be noted that the processing operations subsequent to steps S327 and S346 shown in FIG. 22 are generally the same as the result packet send/receive control processing (or the processing operations subsequent to steps S53 and S72) of FIGS. 8 through 12, so that the description thereof will be omitted for brevity.

Thus, if a REQ signal (drive_REQ) from the recording/reproducing block 12 and a REQ signal (camera_REQ) from the camera block 11 cause interrupts approximately at the same time and, if a command send request comes before the transmission of an ACK signal (drive_ACK) indicative of the acceptance of a REQ signal (camera_REQ) from the camera block 11, the recording/reproducing block 12 prioritizes the command sent request thereof. In response, in accordance with the REQ signal (drive_REQ) or the ACK signal (drive_ACK) from the recording/reproducing block 12, the camera block 11 determines whether the REQ signal (camera_REQ) of the camera block 11 has been accepted.

It should be noted that an example was used in FIGS. 19 through 22 in which the transmission of a result packet is requested from the camera block 11; generally the same processing is executed also in the case of a result packet, description of which will be omitted for brevity.

In the above description, an example was used in which the camera block 11 and the recording/reproducing block 12 constituting the recording/reproducing apparatus 1 are interconnected with serial lines. The present invention is also applicable to the communication of individual apparatuses, such as a camera and a recording/reproducing apparatus. In this case, the present invention is also applicable to the communication of personal computers and CE (Consumer Electronics) equipment including mobile phones, PDAs (Personal Digital Assistants), AV (Audio Visual) devices, and household appliances, for example.

In addition to serial lines, the present invention is applicable to the Internet, LANs (Local Area Networks), and wireless communication, for example.

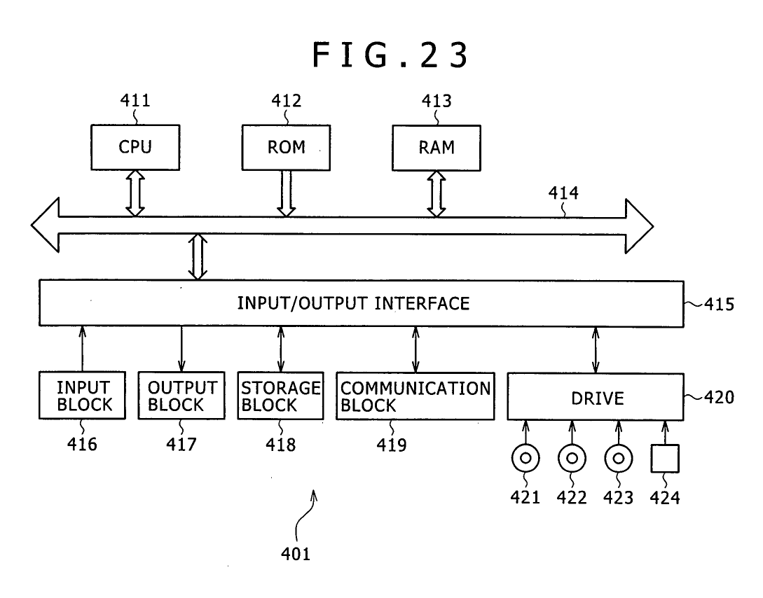

The above-mentioned sequence of processing operations may be executed by software as well as hardware. In this case, the camera block 11 and the recording/reproducing block 12 of the recording/reproducing apparatus 1 shown in FIG. 1 may be configured by a personal computer 401 shown in FIG. 23, for example.

In FIG. 23, a CPU (Central Processing Unit) 411 executes various processing operations as instructed by programs stored in a ROM (Read Only Memory) 412 or programs loaded from a storage block 418 into a RAM (Random Access Memory) 413. The RAM 413 also stores, from time to time, data that is necessary for the CPU 411 to execute various processing operations.

The CPU 411, the ROM 412, and the RAM 413 are interconnected via a bus 414. The bus 414 is also connected to an input/output interface 415.

The input/output interfaced 415 is connected with an input block 416 based on keyboard and mouse for example, an output block 417 based on a display monitor such as CRT (Cathode Ray Tube) or LCD (Liquid Crystal Display) and a speaker for example, the storage block 418 based on HDD (Hard Disc Drive) for example, and a communication block 419 based on modem or terminal adaptor for example. The communication block 419 executes communication processing via a wireless network, for example. It should be noted that the input/output interface 415 is connected with the imaging block 22 (in the case of the camera block 11 shown in FIG. 1) as required.

The input/output interface 415 is also connected with a drive 420 on which a magnetic disc 421, an optical disc 422, a magneto-optical disc 423, or a semiconductor memory 424 is loaded as required, programs read from the loaded recording medium being installed in the storage block 418 as required.

When the above-mentioned sequence of processing operations is executed by software, the programs constituting the software are installed in a computer which is built in dedicated hardware equipment or installed, from a network or recording media, into a general-purpose personal computer for example in which various programs may be installed for the execution of various functions.

It should be noted that each of these programs is not restricted in form as long as it is capable of executing the above-mentioned sequence of processing operations as a whole. For example, the programs may be of a modular structure in which each program is a module corresponding to each of the above-mentioned functional blocks, a module in which part or all of functional blocks are combined, or a module obtained by dividing a functional block. Alternatively, each program may be a program simply having one algorithm.

As shown in FIG. 23, these recording media are constituted by not only a package media made up of the magnetic disk 421 (including flexible disks), the optical disk 422 (including CD-ROM (Compact Disk Read Only Memory) and DVD (Digital Versatile Disk)), the magneto-optical disk 423 (including MD (Mini Disk) (trademark)), or the semiconductor memory 424 which is distributed separately from the apparatus itself, but also the ROM 412 or the storage block 418 which stores programs and is provided to users as incorporated in the apparatus itself.

It should be noted herein that the steps for describing each program recorded in recording media include not only the processing operations which are sequentially executed in a time-dependent manner but also the processing operations which are executed concurrently or discretely (for example, parallel processing or processing based on objects).

The programs may be processed by one computer or by a plurality of computers in a distributed manner. Also, the programs may be transferred to a remote computer or computers for execution.

It should also be noted that term “system” as used herein denotes an entire apparatus configured by a plurality of component units.

While preferred embodiments of the present invention have been described using specific terms, such description is for illustrative purpose only, and it is to be understood that changes and variations may be made without departing from the spirit or scope of the following claims.

1. An information processing system having a first information processing apparatus and a second information processing apparatus for controlling communication with said first information processing apparatus via a network,
said first information processing apparatus comprising:
attaching means for attaching free space information of a send buffer, which comprises data to be transmitted to said second information processing apparatus, to first data to be transmitted to said second information processing apparatus; and
first transmitting means for transmitting said first data attached with the send buffer free space information by said attaching means to said second information processing apparatus;
said second information processing apparatus comprising:
second transmitting means for transmitting second data to said first information processing apparatus;
data receiving means for receiving said first data transmitted from said first information processing apparatus;
free space determining means for determining whether said send buffer free space is smaller than a predetermined value based on said send buffer free space information attached to said first data received by said data receiving means; and
communication control means for, if said send buffer free space is found smaller than said predetermined value by said free space determining means, controlling communication with said first information processing apparatus such that transmission of said first data by said first transmitting means is executed before transmission of said second data by said second transmitting means.

2. The information processing system according to claim 1 wherein,
said second data is control command data; and
said first data is at least one of notification data for notifying that said second data has been received by said first information processing apparatus and result data indicative of a result of processing executed by said first information processing apparatus in response to said second data.

3. An information processing apparatus that executes communication via a network, the apparatus comprising:
receiving means for receiving first data from another information processing apparatus;
attaching means for attaching free space information of a send buffers, which comprises data to be transmitted to said another information processing apparatus, to second data to be transmitted to said another information processing apparatus; and
transmitting means for transmitting said second data attached with the send buffer free space information to said another information processing apparatus;
wherein, if said send buffer free space is found smaller than a predetermined value by said another information processing apparatus based on said send buffer free space information attached to said second data transmitted by said transmitting means, transmission of said second data by said transmitting means is executed before reception of said first data by said receiving means.

4. The information processing apparatus according to claim 3 wherein,
said first data is control command data; and
said second data is at least one of notification data for notifying that said first data has been received by said receiving means and result data indicative of a result of processing executed in accordance with said first data.

5. The information processing apparatus according to claim 4 wherein, if there are said notification data and said result data as candidates for said second data, said transmitting means transmits said notification data rather than said result data.

6. The information processing apparatus according to claim 5, further comprising:
free space determining means for determining a free space of a receive buffer in which said first data received by said receiving means is stored;
wherein, if the receive buffer free space is found smaller than a predetermined value by said free space determining means, said transmitting means puts transmission of said notification data in a standby state and transmits said result data.

7. An information processing method for an information processing apparatus that executes communication via a network, the method comprising the steps of:
receiving first data from another information processing apparatus;
attaching free space information of a send buffers which comprises data to be transmitted to said another information processing apparatus, to second data to be transmitted to said another information processing apparatus; and
transmitting said second data attached with the send buffer free space information to said another information processing apparatus;
wherein, if said send buffer free space is found smaller than a predetermined value by said another information processing apparatus based on said send buffer free space information attached to said second data transmitted in said transmitting step, transmission of said second data in said transmitting step is executed before reception of said first data in said receiving step.

8. A recording medium recording a program for making a computer execute processing of communication via a network, said program comprising the steps of:
receiving first data from another information processing apparatus;
attaching free space information of a send buffers, which comprises data to be transmitted to said another information processing apparatus, to second data to be transmitted to said another information processing apparatus; and
transmitting said second data attached with the send buffer free space information to said another information processing apparatus;
wherein, if said send buffer free space is found smaller than a predetermined value by said another information processing apparatus based on said send buffer free space information attached to said second data transmitted in said transmitting step, transmission of said second data in said transmitting step is executed before reception of said first data in said receiving step.

9. A program for making a computer execute processing of communication via a network, said program comprising the steps of:
receiving first data from another information processing apparatus;
attaching free space information of a send buffers, which comprises data to be transmitted to said another information processing apparatus, to second data to be transmitted to said another information processing apparatus; and
transmitting said second data attached with the send buffer free space information to said another information processing apparatus;
wherein, if said send buffer free space is found smaller than a predetermined value by said another information processing apparatus based on said send buffer free space information attached to said second data transmitted in said transmitting step, transmission of said second data in said transmitting step is executed before reception of said first data in said receiving step.

10. An information processing apparatus for controlling communication to be executed via a network, the apparatus comprising:
transmitting means for transmitting first data to another information processing apparatus;
receiving means for receiving second data attached with free space information of a send buffer of said another information processing apparatus, said second data being transmitted therefrom;
free space determining means for determining whether send buffer free space is smaller than a predetermined value based on said send buffer free space information attached to said second data received by said receiving means; and
communication control means for, if said send buffer free space is found smaller than said predetermined value by said free space determining means, controlling communication with said another information processing apparatus so as to execute reception of said second data by said receiving means before transmission of said first data by said transmitting means.

11. The information processing apparatus according to claim 10 wherein,
said first data is control command data; and
said second data is at least one of notification data for notifying that said first data transmitted by said transmitting means has been received by said another information processing apparatus and result data indicative of a result of processing executed in response to said first data in said another information processing apparatus.

12. The information processing apparatus according to claim 11 wherein said communication control means controls said another information processing apparatus so as to prohibit transmission of next first data by said transmitting means until said receiving means receives, as said second data, said notification data corresponding to said first data transmitted by said transmitting means, thereby preferentially executing reception of said second data by said receiving means.

13. An information processing method for an information processing apparatus for controlling communication to be executed via a network, the method comprising the steps of:
transmitting first data to another information processing apparatus;
receiving second data attached with free space information of a send buffer of said another information processing apparatus, said second data being transmitted therefrom;
determining whether send buffer free space is smaller than a predetermined value based on said send buffer free space information attached to said second data received in said receiving step; and
if said send buffer free space is found smaller than said predetermined value in said free space determining step, controlling communication with said another information processing apparatus so as to execute reception of said second data in said receiving step before transmission of said first data in said transmitting step.

14. A recording medium recording a program for making a computer execute processing of controlling communication to be executed via a network, said program comprising the steps of:
transmitting first data to another information processing apparatus;
receiving second data attached with free space information of a send buffer of said another information processing apparatus, said second data being transmitted therefrom;
determining whether send buffer free space is smaller than a predetermined value based on said send buffer free space information attached to said second data received in said receiving step; and
if said send buffer free space is found smaller than said predetermined value in said free space determining step, controlling communication with said another information processing apparatus so as to execute reception of said second data in said receiving step before transmission of said first data in said transmitting step.

15. A program for making a computer execute processing of controlling communication to be executed via a network, the program comprising the steps of:
transmitting first data to another information processing apparatus;
receiving second data attached with free space information of a send buffer of said another information processing apparatus, said second data being transmitted therefrom;
determining whether send buffer free space is smaller than a predetermined value based on said send buffer free space information attached to said second data received in said receiving step; and
if said send buffer free space is found smaller than said predetermined value in said free space determining step, controlling communication with said another information processing apparatus so as to execute reception of said second data in said receiving step before transmission of said first data in said transmitting step.

16. An information processing system having a first information processing apparatus and a second information processing apparatus for controlling communication with said first information processing apparatus via a network,
said first information processing apparatus comprising:
an attaching section for attaching free space information of a send buffers which comprises data to be transmitted to said second information processing apparatus, to first data to be transmitted to said second information processing apparatus; and
a first transmitting section for transmitting said first data attached with the send buffer free space information by said attaching section to said second information processing apparatus;
said second information processing apparatus comprising:
a second transmitting section for transmitting second data to said first information processing apparatus;
a data receiving section for receiving said first data transmitted from said first information processing apparatus;
a free space determining section for determining whether said send buffer free space is smaller than a predetermined value based on said send buffer free space information attached to said first data received by said data receiving section; and
a communication control section for, if said send buffer free space is found smaller than said predetermined value by said free space determining section, controlling communication with said first information processing apparatus such that transmission of said first data by said first transmitting section is executed before transmission of said second data by said second transmitting section.

17. An information processing apparatus that executes communication via a network, the apparatus comprising:
a receiving section for receiving first data from another information processing apparatus;
an attaching section for attaching free space information of a send buffer, which comprises data to be transmitted to said another information processing apparatus to second data to be transmitted to said another information processing apparatus; and
a transmitting section for transmitting said second data attached with the send buffer free space information to said another information processing apparatus;
wherein, if said send buffer free space is found smaller than a predetermined value by said another information processing apparatus based on said send buffer free space information attached to said second data transmitted by said transmitting section, transmission of said second data by said transmitting section is executed before reception of said first data by said receiving section.

18. An information processing apparatus for controlling communication to be executed via a network, comprising:
a transmitting section for transmitting first data to another information processing apparatus;
a receiving section for receiving second data attached with free space information of a send buffer of said another information processing apparatus, said second data being transmitted therefrom;
a free space determining section for determining whether the send buffer free space is smaller than a predetermined value based on said send buffer free space information attached to said second data received by said receiving section; and a communication control section for, if said send buffer free space is found smaller than said predetermined value by said free space determining section, controlling communication with said another information processing apparatus so as to execute reception of said second data by said receiving section before transmission of said first data by said transmitting section.
